(19) United States
(12) Patent Application Publication
(10) Pub. No.: US 2026/0312013 A1
(43) Pub. Date: Oct. 8, 2026

(54) PRELITHIATED NEGATIVE ELECTRODE PLATE, PREPARATION METHOD OF LITHIUM SUPPLEMENTATION COMPOSITE LAYER, LITHIUM SUPPLEMENTATION METHOD, SECONDARY BATTERY, AND ELECTRONIC APPARATUS

(71) Applicant: Ningde Amperex Technology Limited, Ningde City (CN)

(72) Inventors: Mingju Liu, Ningde City (CN); Yajie Li, Ningde City (CN); Xinghua Tao, Ningde City (CN)

(73) Assignee: Ningde Amperex Technology Limited, Ningde City (CN)

(21) Appl. No.: 19/457,585

(22) Filed: Jan. 23, 2026

(30) Foreign Application Priority Data
Jan. 23, 2025 (CN) 202510111748.7

(51) Int. Cl. H01M 4/36; H01M 4/02; H01M 4/04; H01M 4/38; H01M 4/40; H01M 4/587; H01M 10/0525

(52) U.S. Cl. CPC H01M 4/366; H01M 4/0435; H01M 4/364; H01M 4/386; H01M 4/405; H01M 4/587; H01M 10/0525; H01M 2004/021; H01M 2004/027

(57) ABSTRACT

A prelithiated negative electrode plate includes a negative electrode current collector, a third negative electrode material layer, and a fourth negative electrode material layer, where the third negative electrode material layer is disposed between the negative electrode current collector and the fourth negative electrode material layer, the third negative electrode material layer includes a first negative electrode active material, the fourth negative electrode material layer includes a second negative electrode active material, and the second negative electrode active material includes a silicon-containing substance; and a mass percentage of silicon element in the third negative electrode material layer is WSi₃%, a mass percentage of silicon element in the fourth negative electrode material layer is WSi₄%, and a mass percentage of lithium element in the fourth negative electrode material layer is WLi₄%, where WSi₄>WSi₃, and 1.5%≤WLi₄/WSi₄≤44.4%.

### CROSS-REFERENCE TO RELATED APPLICATIONS

This application claims priority to Chinese Patent Application No. 202510111748.7, filed on Jan. 23, 2025, the whole disclosure of which is incorporated herein by reference.

### TECHNICAL FIELD

This application relates to the field of electrochemical technology, and in particular, to a prelithiated negative electrode plate, a preparation method of lithium supplementation composite layer, a lithium supplementation method, a secondary battery, and an electronic apparatus.

### BACKGROUND

With advantages such as high energy density, high power, and long cycle life, lithium-ion batteries are widely used in consumer electronics, electric bicycles, and electric vehicles. As their application scope continues to expand, the requirements for energy density and cycling performance of lithium-ion batteries are constantly increasing. The currently commonly used graphite material for lithium-ion battery negative electrodes can no longer meet the energy density requirements. Due to the high theoretical specific capacity, silicon-carbon or silicon-oxygen negative electrode materials are ideal materials for improving the energy density of lithium-ion batteries. However, they suffer from issues such as low initial Coulombic efficiency and poor cycle life.

To improve initial Coulombic efficiency and reduce cycling degradation of negative electrode active materials, existing methods involve pre-supplementing lithium to the negative electrode plate to compensate for the irreversible capacity consumed during the initial charge, discharge, and cycling, thereby improving the initial Coulombic efficiency of lithium-ion batteries and further enhancing the energy density of lithium-ion batteries. When negative electrode active materials are a mixture of silicon-carbon or silicon-oxygen negative electrode materials and graphite materials, different negative electrode active materials exhibit different lithium supplementation efficiencies, leading to different amounts of lithium supplemented in the same time period. The initial Coulombic efficiencies of different negative electrode active materials differ, which affects the initial Coulombic efficiency of lithium-ion batteries and hinders the improvement of energy density.

### SUMMARY

The purpose of this application is to provide a prelithiated negative electrode plate, a preparation method of lithium supplementation composite layer, a lithium supplementation method, a secondary battery, and an electronic apparatus, so as to improve initial Coulombic efficiency of the secondary battery, reduce cycling capacity degradation, and enhance energy density of the secondary battery. The specific technical solutions are as follows.

A first aspect of this application provides a preparation method of lithium supplementation composite layer, including the following steps:
(1) applying a lithium metal powder slurry onto a support layer, followed by drying and rolling, to form a lithium supplementation layer; or rolling lithium foil and/or lithium alloy foil onto a support layer to form a lithium supplementation layer; or applying a molten lithium or lithium alloy slurry onto a support layer, followed by cooling and rolling, to form a lithium supplementation layer; where a rolling pressure P1 is 0.2 T/10 mm to 1.8 T/10 mm; and
(2) applying interface particles onto a surface of the lithium supplementation layer to form an interface layer, followed by rolling, to form a lithium supplementation composite layer, where a rolling pressure P2 is 0.2 T/10 mm to 1.8 T/10 mm, and preferably, the rolling pressure P2 is 0.2 T/10 mm to 0.8 T/10 mm; a rolling temperature T1 is 20° C. to 180° C., and preferably, the rolling temperature T1 is 50° C. to 120° C.; and a rolling rest time t1 is 5 min to 60 min, and preferably, the rolling rest time t1 is 10 min to 30 min.

The lithium supplementation composite layer is prepared using the foregoing method, followed by prelithiation treatment of the negative electrode plate, to obtain a prelithiated negative electrode plate. In the prelithiated negative electrode plate, both the second negative electrode active material and the first negative electrode active material have a relatively high lithium supplementation amount, which can improve the initial Coulombic efficiency of the secondary battery, reduce cycling capacity degradation, and enhance the energy density of the secondary battery.

In one embodiment of this application, the lithium supplementation composite layer includes a support layer, a lithium supplementation layer, and an interface layer, where the lithium supplementation layer is disposed between the support layer and the interface layer; the interface layer includes interface particles, where the interface particles include at least one of a conductive agent or a lithiation material, the conductive agent includes at least one of conductive carbon black, carbon fiber, graphene, or carbon nanotubes, and the lithiation material includes at least one of artificial graphite, natural graphite, hard carbon, silicon-carbon material, silicon-oxygen material, lithium titanate, tin, or tin-copper alloy; and the lithium supplementation layer includes at least one of lithium foil or lithium alloy foil. When the lithium supplementation composite layer satisfies the above structure, the use of the foregoing interface particles allows the interface layer to have good electron and ion conductivity, which facilitates the rapid transfer of electrons and lithium ions through the interface layer to the surface or interior of the second negative electrode material layer and the first negative electrode material layer during prelithiation, facilitating further lithium supplementation to the negative electrode plate. This can further improve the initial Coulombic efficiency of the secondary battery, further reduce cycling capacity degradation, and further enhance the energy density of the secondary battery.

In one embodiment of this application, the interface particles include a lithiation material and a conductive agent, and based on a mass of the interface particles, a mass percentage of the lithiation material is 80% to 99%, and a mass percentage of the conductive agent is 1% to 20%. When the interface particles include a lithiation material and a conductive agent, and the mass percentages of the lithiation material and the conductive agent are within the ranges of this application, the electron and ion conductivity of the interface layer can be further improved, which facilitates the faster transfer of electrons and lithium ions through the interface layer to the surface or interior of the second negative electrode material layer and the first negative electrode material layer during prelithiation, facilitating further lithium supplementation to the negative electrode plate. This can further improve the initial Coulombic efficiency of the secondary battery, further reduce cycling capacity degradation, and further enhance the energy density of the secondary battery.

In one embodiment of this application, a thickness of the interface layer is 0.1 μm to 50 μm, and preferably, the thickness of the interface layer is 1 μm to 20 km.

In one embodiment of this application, a thickness of the lithium supplementation layer is 0.001 mm to 1 mm, and preferably, the thickness of the lithium supplementation layer is 0.005 mm to 0.1 mm.

In one embodiment of this application, the support layer includes at least one of metal foil, polyethylene terephthalate film, polypropylene film, polyethylene film, or polyimide film, and the metal foil includes copper foil, nickel foil, steel foil, or copper-nickel alloy foil.

In one embodiment of this application, along a tape-running direction of the lithium supplementation composite layer, a tensile strength of the support layer is 0.5 N/10 mm to 200 N/10 mm, and preferably, the tensile strength of the support layer is 1 N/10 mm to 100 N/10 mm.

In one embodiment of this application, a thickness of the support layer is 3 m to 50 μm, and preferably, the thickness of the support layer is 5 μm to 20 km.

A second aspect of this application provides a lithium supplementation method, including the following steps:
drying a negative electrode plate, where the negative electrode plate includes a negative electrode current collector, a first negative electrode material layer, and a second negative electrode material layer, where along a thickness direction of the negative electrode plate, the first negative electrode material layer is disposed between the negative electrode current collector and the second negative electrode material layer, and the second negative electrode material layer includes a silicon-containing substance; and based on a mass of the first negative electrode material layer, a mass percentage of silicon element in the first negative electrode material layer is WSi₁%, and based on a mass of the second negative electrode material layer, a mass percentage of silicon element in the second negative electrode material layer is WSi₂%, where WSi₂>WSi₁; and laminating the lithium supplementation composite layer prepared using the preparation method according to any one of the foregoing embodiments with the negative electrode plate to bring the interface layer and the second negative electrode material layer into contact, performing prelithiation treatment, and after the prelithiation treatment ends, peeling off the lithium supplementation composite layer from the negative electrode plate to form a prelithiated negative electrode plate.

The lithium supplementation method according to this application is used to prepare a prelithiated negative electrode plate. In the prelithiated negative electrode plate, both the second negative electrode active material and the first negative electrode active material have a relatively high lithium supplementation amount, which can improve the initial Coulombic efficiency of the secondary battery, reduce cycling capacity degradation, and enhance the energy density of the secondary battery.

In one embodiment of this application, during the prelithiation treatment, an interface pressure P3 between the interface layer and the second negative electrode material layer is 0.1 MPa to 2 MPa, and preferably, the interface pressure P3 between the interface layer and the second negative electrode material layer is 0.2 MPa to 1.0 MPa; a lamination time t2 between the interface layer and the second negative electrode material layer is 0.5 h to 72 h, and preferably, the lamination time t2 between the interface layer and the second negative electrode material layer is 1 h to 48 h; and a lamination temperature T2 between the interface layer and the second negative electrode material layer is 50° C. to 180° C., and preferably, the lamination temperature T2 between the interface layer and the second negative electrode material layer is 60° C. to 160° C. By controlling the interface pressure, lamination time, and lamination temperature within the ranges of this application, the initial Coulombic efficiency of the secondary battery can be further improved, cycling capacity degradation can be further reduced, and the energy density of the secondary battery can be further enhanced.

A third aspect of this application provides a prelithiated negative electrode plate prepared using the lithium supplementation method according to any one of the foregoing embodiments, where the negative electrode plate includes a negative electrode current collector, a third negative electrode material layer, and a fourth negative electrode material layer, where along a thickness direction of the negative electrode plate, the third negative electrode material layer is disposed between the negative electrode current collector and the fourth negative electrode material layer, the third negative electrode material layer includes a first negative electrode active material, the fourth negative electrode material layer includes a second negative electrode active material, and the second negative electrode active material includes a silicon-containing substance; and based on a mass of the third negative electrode material layer, a mass percentage of silicon element in the third negative electrode material layer is WSi₃%, and based on a mass of the fourth negative electrode material layer, a mass percentage of silicon element in the fourth negative electrode material layer is WSi₄%, and a mass percentage of lithium element in the fourth negative electrode material layer is WLi₄%, where WSi₄>WSi₃, and 1.5%≤WLi₄/WSi₄≤44.4%. The foregoing prelithiated negative electrode plate, when applied to a secondary battery, can improve the initial Coulombic efficiency of the secondary battery, reduce cycling capacity degradation, and enhance the energy density of the secondary battery. Additionally, the fourth negative electrode material layer includes a silicon-containing substance, helping improve the kinetic performance of the secondary battery.

In one embodiment of this application, based on a mass of the third negative electrode material layer, a mass percentage of lithium element in the third negative electrode material layer is WLi₃%, where 1.1≤WLi₄/WLi₃≤4.8, preferably 1.4≤WLi₄/WLi₃≤3.3; and 0.2≤WLi₄≤4.4. When the mass percentage of lithium element in the fourth negative electrode material layer and its ratio to the mass percentage of lithium element in the third negative electrode material layer are within the ranges of this application, both the second negative electrode active material and the first negative electrode active material have a relatively high lithium supplementation amount, which can further improve the initial Coulombic efficiency of the secondary battery, further reduce cycling capacity degradation, and further enhance the energy density of the secondary battery.

In one embodiment of this application, 0.9≤WSi₄≤43.5. When the negative electrode plate satisfies the above structure, and the mass percentage of silicon element in the fourth negative electrode material layer is within the range of this application, the second negative electrode active material has a relatively high lithium supplementation amount, which can further improve the initial Coulombic efficiency of the secondary battery, further reduce cycling capacity degradation, and further enhance the energy density of the secondary battery.

In one embodiment of this application, based on a mass of the second negative electrode active material, a mass percentage of the silicon-containing substance is S₂%, where 2≤S₂≤100. When the negative electrode plate satisfies the above structure, and the mass percentage of the silicon-containing substance in the second negative electrode active material is within the range of this application, the second negative electrode active material has a relatively high lithium supplementation amount, which can further improve the initial Coulombic efficiency of the secondary battery, further reduce cycling capacity degradation, and further enhance the energy density of the secondary battery.

In one embodiment of this application, based on the mass of the third negative electrode material layer, a mass percentage of the first negative electrode active material is H %, and based on the mass of the fourth negative electrode material layer, a mass percentage of the second negative electrode active material is H₂%, where 0.1≤H₂−H₁≤10, preferably 1≤H₂−H₁≤5. When the difference between the mass percentage of the second negative electrode active material and the mass percentage of the first negative electrode active material is within the range of this application, the mass percentage of the second negative electrode active material matches the mass percentage of the first negative electrode active material, allowing for regulation of the mass percentages of silicon element and lithium element in different negative electrode material layers, so that both the second negative electrode active material and the first negative electrode active material have a relatively high lithium supplementation amount. This can further improve the initial Coulombic efficiency of the secondary battery, further reduce cycling capacity degradation, and further enhance the energy density of the secondary battery.

In one embodiment of this application, an areal density of the third negative electrode material layer is CW₃ mg/cm², and an areal density of the fourth negative electrode material layer is CW₄ mg/cm², where 0.8≤CW₃≤50, preferably 1.0≤CW₃≤13.0; and 0.25≤CW₄/CW₃≤1. When the areal density of the third negative electrode material layer and the ratio of the areal density of the fourth negative electrode material layer to the areal density of the third negative electrode material layer are within the ranges of this application, the areal density of the third negative electrode material layer matches the areal density of the fourth negative electrode material layer, allowing both the second negative electrode active material and the first negative electrode active material to have a relatively high lithium supplementation amount. This can further improve the initial Coulombic efficiency of the secondary battery, further reduce cycling capacity degradation, and further enhance the energy density of the secondary battery.

In one embodiment of this application, the silicon-containing substance includes at least one of a silicon-carbon material or a silicon-oxygen material. When the negative electrode plate satisfies the above structure, the use of the foregoing silicon-containing substance allows the second negative electrode active material to have a relatively high lithium supplementation amount. This can further improve the initial Coulombic efficiency of the secondary battery, further reduce cycling capacity degradation, and further enhance the energy density of the secondary battery.

A fourth aspect of this application provides a secondary battery including the prelithiated negative electrode plate according to any one of the foregoing embodiments. Therefore, the secondary battery provided in this application has a high initial Coulombic efficiency, low cycling capacity degradation, and high energy density.

A fifth aspect of this application provides an electronic apparatus including the secondary battery according to any one of the foregoing embodiments. Therefore, the electronic apparatus provided in this application has a high initial Coulombic efficiency, low cycling capacity degradation, and high energy density.

### Beneficial Effects of this Application

This application provides a prelithiated negative electrode plate, a preparation method of lithium supplementation composite layer, a lithium supplementation method, a secondary battery, and an electronic apparatus. The prelithiated negative electrode plate includes a negative electrode current collector, a third negative electrode material layer, and a fourth negative electrode material layer, where along a thickness direction of the negative electrode plate, the third negative electrode material layer is disposed between the negative electrode current collector and the fourth negative electrode material layer, the third negative electrode material layer includes a first negative electrode active material, the fourth negative electrode material layer includes a second negative electrode active material, and the second negative electrode active material includes a silicon-containing substance; and based on a mass of the third negative electrode material layer, a mass percentage of silicon element in the third negative electrode material layer is WSi₃%, and based on a mass of the fourth negative electrode material layer, a mass percentage of silicon element in the fourth negative electrode material layer is WSi₄%, and a mass percentage of lithium element in the fourth negative electrode material layer is WLi₄%, where WSi₄>WSi₃, and 1.5%≤WLi₄/WSi₄≤44.4%. The prelithiated negative electrode plate satisfying the foregoing characteristics can improve initial Coulombic efficiency of the secondary battery, reduce cycling capacity degradation, and enhance energy density of the secondary battery.

Certainly, implementing any product or method of this application does not necessarily require all the advantages described above.

### DESCRIPTION OF THE DRAWINGS

To describe the technical solutions in the embodiments of this application or in the prior art more clearly, the following briefly describes the accompanying drawings for describing the embodiments or the prior art. Apparently, the accompanying drawings in the following description show merely some embodiments of this application, and persons of ordinary skill in the art may still derive other embodiments from these accompanying drawings without creative efforts.

FIG. 1 is a schematic structural diagram of a lithium supplementation composite layer according to an embodiment of this application;

FIG. 2 is a schematic structural diagram of a negative electrode plate and a lithium supplementation composite layer during prelithiation according to an embodiment of this application; and

FIG. 3 is a schematic structural diagram of a prelithiated negative electrode plate according to an embodiment of this application.

### DETAILED DESCRIPTION

The following clearly and completely describes the technical solutions in the embodiments of this application with reference to the accompanying drawings in the embodiments of this application. Apparently, the described embodiments are merely some but not all embodiments of this application. All other embodiments obtained by those skilled in the art based on this application fall within the scope of protection of this application.

It should be noted that, in the specific embodiments of this application, a lithium-ion battery is used as an example of a secondary battery to explain this application, but the secondary battery of this application is not limited to lithium-ion batteries.

A first aspect of this application provides a preparation method of lithium supplementation composite layer, including the following steps:
(1) under conditions of ambient temperature ≤30° C. and humidity ≤1.7%, applying a lithium metal powder slurry onto a support layer, followed by drying and rolling, to form a lithium supplementation layer; or rolling lithium foil and/or lithium alloy foil onto a support layer to form a lithium supplementation layer; or applying a molten lithium or lithium alloy slurry onto a support layer, followed by cooling and rolling, to form a lithium supplementation layer; where a rolling pressure P1 is 0.2 T/10 mm to 1.8 T/10 mm; specifically, a rolling pressure P11 for rolling after the lithium metal powder slurry is applied onto the support layer is 0.2 T/10 mm to 1.8 T/10 mm; a rolling pressure P12 for rolling the lithium foil and/or lithium alloy foil onto the support layer is 0.2 T/10 mm to 1.8 T/10 mm; and a rolling pressure P13 for rolling after the molten lithium or lithium alloy slurry is applied onto the support layer is 0.2 T/10 mm to 1.8 T/10 mm; and
(2) under conditions of ambient temperature ≤30° C. and humidity ≤1.7%, applying interface particles onto a surface of the lithium supplementation layer to form an interface layer, followed by rolling, to form a lithium supplementation composite layer, where a rolling pressure P2 is 0.2 T/10 mm to 1.8 T/10 mm, and preferably, the rolling pressure P2 is 0.2 T/10 mm to 0.8 T/10 mm; a rolling temperature T1 is 20° C. to 180° C., and preferably, the rolling temperature T1 is 50° C. to 120° C.; and a rolling rest time t1 is 5 min to 60 min, and preferably, the rolling rest time t1 is 10 min to 30 min.

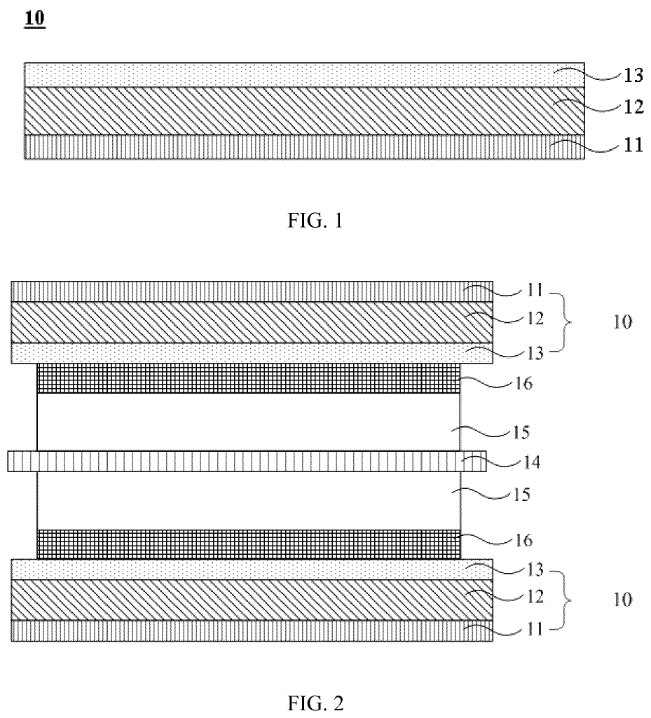

The inventors have found through research that using the preparation method of lithium supplementation composite layer provided in this application to prepare a lithium supplementation composite layer, as shown in FIG. 1, the lithium supplementation composite layer 10 includes a support layer 11, a lithium supplementation layer 12, and an interface layer 13, where the lithium supplementation layer 12 is disposed between the support layer 11 and the interface layer 13, and the interface layer has electron and ion conductivity. Taking a non-prelithiated negative electrode plate, as shown in FIG. 2, the interface layer 13 is brought into contact with a second negative electrode material layer 16, causing an internal short circuit between the lithium supplementation layer 12 and the second negative electrode material layer 16. Lithium atoms in the lithium supplementation layer 12 undergo an oxidation reaction, losing electrons to generate lithium ions. Electrons and lithium ions are first transferred through the interface layer 13 to a surface or an interior of the second negative electrode material layer 16, and then to a surface or an interior of a first negative electrode material layer 15. Electrons and lithium ions undergo a reduction reaction in the first negative electrode material layer 15 and the second negative electrode material layer 16 to form lithium-intercalated compounds, implementing prelithiation of the first negative electrode material layer 15 and the second negative electrode material layer 16. Since an interface layer is disposed between the lithium supplementation layer and the second negative electrode material layer, the likelihood of the lithium supplementation layer adhering to the surface of the second negative electrode material layer can be reduced, thereby reducing the impact of side reactions caused by the high activity of lithium metal in the lithium supplementation layer on the electrochemical performance of the secondary battery. After the prelithiation treatment ends, the lithium supplementation composite layer is peeled off from the negative electrode plate to obtain a prelithiated negative electrode plate. This peeling process can reduce the impact of side reactions, caused by elemental lithium metal in the lithium supplementation layer remaining on the surface of the second negative electrode material layer and entering the secondary battery, on the electrochemical performance of the secondary battery. The foregoing method is used to prepare the lithium supplementation composite layer, followed by prelithiation treatment of the negative electrode plate, to obtain a prelithiated negative electrode plate. In the prelithiated negative electrode plate, both the second negative electrode active material and the first negative electrode active material have a relatively high lithium supplementation amount, which can improve the initial Coulombic efficiency of the secondary battery, reduce cycling capacity degradation, and enhance the energy density of the secondary battery.

For example, P11 may be 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, or in a range defined by any two of the above values. P12 may be 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, or in a range defined by any two of the above values. P13 may be 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, or in a range defined by any two of the above values. P2 can be 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, or in a range defined by any two of the above values. T1 may be 20° C., 40° C., 50° C., 60° C., 80° C., 100° C., 120° C., 140° C., 160° C., 180° C., or in a range defined by any two of the above values. t1 may be 5 min, 9 min, 10 min, 15 min, 19 min, 20 min, 25 min, 29 min, 30 min, 35 min, 39 min, 40 min, 45 min, 49 min, 50 min, 55 min, 59 min, 60 min, or in a range defined by any two of the above values.

In this application, the lithium supplementation layer may be formed by applying a lithium metal powder slurry, followed by rolling; or the lithium supplementation layer may be formed by rolling lithium foil and/or lithium alloy foil onto the support layer; or the lithium supplementation layer may be formed by applying a molten lithium or lithium alloy slurry onto the support layer, followed by cooling and rolling. In this application, the lithium alloy foil may include, but is not limited to, lithium-aluminum alloy, and the lithium alloy in the molten lithium alloy slurry may include, but is not limited to, lithium-aluminum alloy. The rolling pressure refers to a force applied to a sample passing through the roller gap, by placing two cylindrical rollers in parallel and controlling the roller gap and the pressure between the upper and lower rollers. This application does not specifically limit the coating method for applying interface particles to the surface of the lithium supplementation layer, as long as the purpose of this application can be achieved. For example, the interface particles can be applied onto the surface of the lithium supplementation layer by electrostatic spraying, roller coating, or wiping.

In one embodiment of this application, the lithium supplementation composite layer includes a support layer, a lithium supplementation layer, and an interface layer, where the lithium supplementation layer is disposed between the support layer and the interface layer; the interface layer includes interface particles, where the interface particles include at least one of a conductive agent or a lithiation material, the conductive agent includes at least one of conductive carbon black, carbon fiber, graphene, or carbon nanotubes, and the lithiation material includes at least one of artificial graphite, natural graphite, hard carbon, silicon-carbon material, silicon-oxygen material, lithium titanate, tin, or tin-copper alloy; and the lithium supplementation layer includes at least one of lithium foil or lithium alloy foil. In this application, the conductive carbon black may include, but is not limited to, at least one of Super P, acetylene black, or Ketjen black; the carbon fiber may include, but is not limited to, at least one of vapor-grown carbon fiber (VGCF) or carbon nanofiber; and the carbon nanotubes may include, but are not limited to, at least one of single-walled carbon nanotubes, multi-walled carbon nanotubes, or few-walled carbon nanotubes. When the lithium supplementation composite layer satisfies the above structure, the use of the foregoing interface particles allows the interface layer to have good electron and ion conductivity, which facilitates the rapid transfer of electrons and lithium ions through the interface layer to the surface or interior of the second negative electrode material layer and the first negative electrode material layer during prelithiation, facilitating further lithium supplementation to the negative electrode plate. This can further improve the initial Coulombic efficiency of the secondary battery, further reduce cycling capacity degradation, and further enhance the energy density of the secondary battery.

In one embodiment of this application, the interface particles include a lithiation material and a conductive agent, and based on a mass of the interface particles, a mass percentage of the lithiation material is 80% to 99%, and a mass percentage of the conductive agent is 1% to 20%. For example, based on the mass of the interface particles, the mass percentage of the lithiation material may be 80%, 81%, 83%, 85%, 87%, 89%, 90%, 91%, 93%, 95%, 97%, 99%, or in a range defined by any two of the above values, and the mass percentage of the conductive agent may be 1%, 3%, 5%, 7%, 9%, 10%, 11%, 13%, 15%, 17%, 19%, 20%, or in a range defined by any two of the above values. When the interface particles include a lithiation material and a conductive agent, and the mass percentages of the lithiation material and the conductive agent are within the ranges of this application, the electron and ion conductivity of the interface layer can be further improved, which facilitates the faster transfer of electrons and lithium ions through the interface layer to the surface or interior of the second negative electrode material layer and the first negative electrode material layer during prelithiation, facilitating further lithium supplementation to the negative electrode plate. This can further improve the initial Coulombic efficiency of the secondary battery, further reduce cycling capacity degradation, and further enhance the energy density of the secondary battery.

In one embodiment of this application, a thickness of the interface layer is 0.1 μm to 50 μm, and preferably, the thickness of the interface layer is 1 μm to 20 km. For example, the thickness of the interface layer may be 0.1, 0.5, 1, 5, 10, 15, 20, 25, 30, 35, 40, 45, 50, or in a range defined by any two of the above values.

In one embodiment of this application, a thickness of the lithium supplementation layer is 0.001 mm to 1 mm, and preferably, the thickness of the lithium supplementation layer is 0.005 mm to 0.1 mm. For example, the thickness of the lithium supplementation layer may be 0.001, 0.003, 0.005, 0.007, 0.009, 0.01, 0.03, 0.05, 0.07, 0.09, 0.1, 0.3, 0.5, 0.7, 0.9, 1, or in a range defined by any two of the above values.

In one embodiment of this application, the support layer includes at least one of metal foil, polyethylene terephthalate film, polypropylene film, polyethylene film, or polyimide film, and the metal foil includes copper foil, nickel foil, steel foil, or copper-nickel alloy foil.

In one embodiment of this application, along a tape-running direction of the lithium supplementation composite layer, a tensile strength of the support layer is 0.5 N/10 mm to 200 N/10 mm, and preferably, the tensile strength of the support layer is 1 N/10 mm to 100 N/10 mm. For example, the tensile strength of the support layer may be 0.5 N/10 mm, 1 N/10 mm, 5 N/10 mm, 10 N/10 mm, 50 N/10 mm, 100 N/10 mm, 150 N/10 mm, 200 N/10 mm, or in a range defined by any two of the above values.

In one embodiment of this application, a thickness of the support layer is 3 m to 50 μm, and preferably, the thickness of the support layer is 5 μm to 20 μm. For example, the thickness of the support layer may be 3, 5, 10, 15, 20, 25, 30, 35, 40, 45, 50, or in a range defined by any two of the above values.

A second aspect of this application provides a lithium supplementation method, including the following steps:
drying a negative electrode plate until the water content is less than or equal to 500 ppm, where the negative electrode plate includes a negative electrode current collector, a first negative electrode material layer, and a second negative electrode material layer, where along a thickness direction of the negative electrode plate, the first negative electrode material layer is disposed between the negative electrode current collector and the second negative electrode material layer, and the second negative electrode material layer includes a silicon-containing substance; and based on a mass of the first negative electrode material layer, a mass percentage of silicon element in the first negative electrode material layer is WSi₁%, and based on a mass of the second negative electrode material layer, a mass percentage of silicon element in the second negative electrode material layer is WSi₂%, where WSi₂>WSi₁; and under conditions of an ambient temperature of 25° C. to 180° C. and a humidity of less than or equal to 1.7%, laminating the lithium supplementation composite layer prepared using the preparation method according to any one of the foregoing embodiments with the negative electrode plate to bring the interface layer and the second negative electrode material layer into contact, performing prelithiation treatment, and after the prelithiation treatment ends, peeling off the lithium supplementation composite layer from the negative electrode plate to form a prelithiated negative electrode plate.

In this application, the non-prelithiated negative electrode plate includes a negative electrode current collector, a first negative electrode material layer, and a second negative electrode material layer. Prelithiation treatment is performed on the non-prelithiated negative electrode plate to obtain a prelithiated negative electrode plate. The prelithiated negative electrode plate includes a negative electrode current collector, a third negative electrode material layer, and a fourth negative electrode material layer. It can be understood that the first negative electrode material layer before prelithiation corresponds to the third negative electrode material layer after prelithiation, and the second negative electrode material layer before prelithiation corresponds to the fourth negative electrode material layer after prelithiation. The first negative electrode material layer includes a first negative electrode active material, and the second negative electrode material layer includes a second negative electrode active material.

The lithium supplementation method according to this application is used to prepare a prelithiated negative electrode plate. In the prelithiated negative electrode plate, both the second negative electrode active material and the first negative electrode active material have a relatively high lithium supplementation amount, which can improve the initial Coulombic efficiency of the secondary battery, reduce cycling capacity degradation, and enhance the energy density of the secondary battery.

In one embodiment of this application, during the prelithiation treatment, an interface pressure P3 between the interface layer and the second negative electrode material layer is 0.1 MPa to 2 MPa, and preferably, the interface pressure P3 between the interface layer and the second negative electrode material layer is 0.2 MPa to 1.0 MPa; a lamination time t2 between the interface layer and the second negative electrode material layer is 0.5 h to 72 h, and preferably, the lamination time t2 between the interface layer and the second negative electrode material layer is 1 h to 48 h; and a lamination temperature T2 between the interface layer and the second negative electrode material layer is 50° C. to 180° C., and preferably, the lamination temperature T2 between the interface layer and the second negative electrode material layer is 60° C. to 160° C. By controlling the interface pressure, lamination time, and lamination temperature within the ranges of this application, the initial Coulombic efficiency of the secondary battery can be further improved, cycling capacity degradation can be further reduced, and the energy density of the secondary battery can be further enhanced.

For example, P3 may be 0.1 MPa, 0.2 MPa, 0.4 MPa, 0.6 MPa, 0.8 MPa, 1.0 MPa, 1.2 MPa, 1.4 MPa, 1.6 MPa, 1.8 MPa, 2 MPa, or in a range defined by any two of the above values. t2 may be 0.5 h, 1 h, 5 h, 10 h, 15 h, 20 h, 25 h, 30 h, 35 h, 40 h, 45 h, 48 h, 50 h, 55 h, 60 h, 65 h, 70 h, 72 h, or in a range defined by any two of the above values. T2 may be 50° C., 60° C., 70° C., 80° C., 90° C., 100° C., 110° C., 120° C., 130° C., 140° C., 150° C., 160° C., 170° C., 180° C., or in a range defined by any two of the above values.

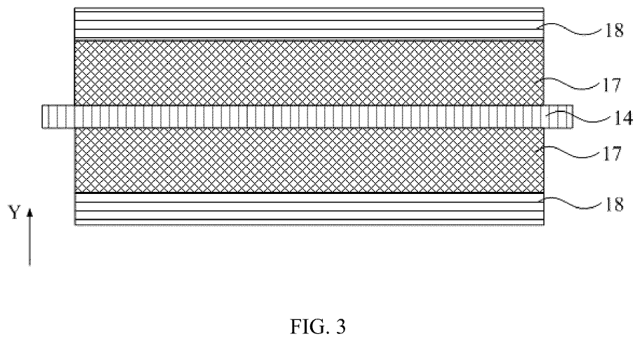

A third aspect of this application provides a prelithiated negative electrode plate prepared using the lithium supplementation method according to any one of the foregoing embodiments. As shown in FIG. 3, the prelithiated negative electrode plate includes a negative electrode current collector 14, a third negative electrode material layer 17, and a fourth negative electrode material layer 18, where along a thickness direction of the negative electrode plate, that is, a direction Y, the third negative electrode material layer 17 is disposed between the negative electrode current collector 14 and the fourth negative electrode material layer 18, the third negative electrode material layer 17 includes a first negative electrode active material, the fourth negative electrode material layer 18 includes a second negative electrode active material, and the second negative electrode active material includes a silicon-containing substance; and based on a mass of the third negative electrode material layer, a mass percentage of silicon element in the third negative electrode material layer is WSi₃%, and based on a mass of the fourth negative electrode material layer, a mass percentage of silicon element in the fourth negative electrode material layer is WSi₄%, and a mass percentage of lithium element in the fourth negative electrode material layer is WLi₄%, where WSi₄>WSi₃, and 1.5%≤WLi₄/WSi₄≤44.4%. For example, the value of WLi₄/WSi₄ may be 1.5%, 5%, 7%, 9%, 10%, 15%, 17%, 19%, 20%, 25%, 27%, 29%, 30%, 35%, 37%, 39%, 40%, 44.4%, or in a range defined by any two of the above values. In this application, the third negative electrode material layer and the fourth negative electrode material layer may be sequentially disposed on one surface of the negative electrode current collector along its thickness direction, or the third negative electrode material layer and the fourth negative electrode material layer may be sequentially disposed on two surfaces of the negative electrode current collector along its thickness direction. It should be noted that the “surface” herein may be the entire region of the negative electrode current collector or a partial region of the negative electrode current collector, which is not specifically limited in this application, as long as the purpose of this application can be achieved. In some embodiments of this application, WSi₃=0.

The inventors have found through research that, within the same prelithiation treatment time, different negative electrode active materials exhibit different lithium supplementation efficiencies, with the silicon-containing substance having a lower lithium supplementation amount and the carbon material having a higher lithium supplementation amount, which affects the initial Coulombic efficiency of the silicon-containing substance. A non-prelithiated negative electrode plate is taken. The negative electrode plate includes a negative electrode current collector, a first negative electrode material layer, and a second negative electrode material layer, where along a thickness direction of the negative electrode plate, the first negative electrode material layer is disposed between the negative electrode current collector and the second negative electrode material layer, the second negative electrode material layer includes a silicon-containing substance, the first negative electrode material layer does not include a silicon-containing substance, and the first negative electrode material layer includes a carbon material. Prelithiation treatment is performed on the non-prelithiated negative electrode plate, to preferentially supplement lithium to the silicon-containing substance in the second negative electrode material layer, and then supplement lithium to the carbon material in the first negative electrode material layer, to obtain a prelithiated negative electrode plate. When the negative electrode plate satisfies the above structure, and the mass percentage of the silicon-containing substance in different negative electrode material layers is within the range of this application, targeted lithium supplementation can be implemented for the silicon-containing substance in the second negative electrode material layer, thereby improving the lithium supplementation efficiency of the silicon-containing substance. The prelithiated negative electrode plate includes a negative electrode current collector, a third negative electrode material layer, and a fourth negative electrode material layer, where along a thickness direction of the negative electrode plate, the third negative electrode material layer is disposed between the negative electrode current collector and the fourth negative electrode material layer, the third negative electrode material layer includes a first negative electrode active material, the fourth negative electrode material layer includes a second negative electrode active material, the second negative electrode active material includes a silicon-containing substance, the first negative electrode active material does not include a silicon-containing substance, and the first negative electrode active material includes a carbon material. When a mass percentage of silicon element in the fourth negative electrode material layer is greater than a mass percentage of silicon element in the third negative electrode material layer, and a ratio of a mass percentage of lithium element to the mass percentage of silicon element in the fourth negative electrode material layer is within the range of this application, both the second negative electrode active material and the first negative electrode active material have a relatively high lithium supplementation amount. The foregoing prelithiated negative electrode plate, when applied to a secondary battery, can improve the initial Coulombic efficiency of the secondary battery, reduce cycling capacity degradation, and enhance the energy density of the secondary battery. Additionally, the fourth negative electrode material layer includes a silicon-containing substance, helping improve the kinetic performance of the secondary battery.

In this application, the carbon material includes at least one of artificial graphite, natural graphite, hard carbon, mesophase carbon microbeads (MCMB), or soft carbon.

In one embodiment of this application, based on a mass of the third negative electrode material layer, a mass percentage of lithium element in the third negative electrode material layer is WLi₃%, where 1.1≤WLi₄/WLi₃≤4.8, preferably 1.4≤WLi₄/WLi₃≤3.3. For example, the value of WLi₄/WLi₃ may be 1.1, 1.4, 1.5, 2.0, 2.5, 3.0, 3.3, 3.5, 4.0, 4.5, 4.8, or in a range defined by any two of the above values; and 0.2≤WLi₄≤4.4. For example, the value of WLi₄ may be 0.2, 0.4, 0.6, 0.8, 1, 1.2, 1.4, 1.6, 1.8, 2, 2.2, 2.4, 2.6, 2.8, 3, 3.2, 3.4, 3.6, 3.8, 4, 4.2, 4.4, or in a range defined by any two of the above values. When the mass percentage of lithium element in the fourth negative electrode material layer and its ratio to the mass percentage of lithium element in the third negative electrode material layer are within the ranges of this application, both the second negative electrode active material and the first negative electrode active material have a relatively high lithium supplementation amount, which can further improve the initial Coulombic efficiency of the secondary battery, further reduce cycling capacity degradation, and further enhance the energy density of the secondary battery. In this application, 0.08≤WLi₃≤0.92. For example, the value of WLi₃ may be 0.08, 0.1, 0.2, 0.3, 0.4, 0.5, 0.6, 0.7, 0.8, 0.9, 0.92, or in a range defined by any two of the above values.

This application does not specifically limit the method for controlling the mass percentage of silicon element in the fourth negative electrode material layer, as long as the purpose of this application can be achieved. For example, the mass percentage of silicon element in the fourth negative electrode material layer can be controlled by adjusting the mass percentage of the silicon-containing substance added to the fourth negative electrode material layer. This application does not specifically limit the method for controlling the mass percentage of lithium element in the third negative electrode material layer and the mass percentage of lithium element in the fourth negative electrode material layer, as long as the purpose of this application can be achieved. For example, the mass percentage of lithium element in the third negative electrode material layer and the mass percentage of lithium element in the fourth negative electrode material layer can be controlled by adjusting the lamination time, lamination temperature, or interface pressure during the prelithiation treatment. This application does not specifically limit the method for controlling WLi₄/WSi₄, as long as the purpose of this application can be achieved. For example, the value of WLi₄/WSi₄ can be controlled by adjusting the respective values of WLi₄ and WSi₄, with the adjustment methods as described above. This application does not specifically limit the method for controlling WLi₄/WLi₃, as long as the purpose of this application can be achieved. For example, the value of WLi₄/WLi₃ can be controlled by adjusting the respective values of WLi₄ and WLi₃, with the adjustment methods as described above.

In one embodiment of this application, 0.9≤WSi₄≤43.5. For example, the value of WSi₄ may be 0.9, 1, 5, 10, 15, 20, 25, 30, 35, 40, 42, 43.5, or in a range defined by any two of the above values. When the negative electrode plate satisfies the above structure, and the mass percentage of silicon element in the fourth negative electrode material layer is within the range of this application, the second negative electrode active material has a relatively high lithium supplementation amount, which can further improve the initial Coulombic efficiency of the secondary battery, further reduce cycling capacity degradation, and further enhance the energy density of the secondary battery.

In one embodiment of this application, based on a mass of the second negative electrode active material, a mass percentage of the silicon-containing substance is S₂%, where 2≤S₂≤100. For example, the value of S₂ can be 2, 5, 10, 15, 20, 25, 30, 35, 40, 45, 50, 55, 60, 65, 70, 75, 80, 85, 90, 95, 100, or in a range defined by any two of the above values. When the negative electrode plate satisfies the above structure, and the mass percentage of the silicon-containing substance in the second negative electrode active material is within the range of this application, the second negative electrode active material has a relatively high lithium supplementation amount, which can further improve the initial Coulombic efficiency of the secondary battery, further reduce cycling capacity degradation, and further enhance the energy density of the secondary battery. This application does not specifically limit the method for controlling the mass percentage of the silicon-containing substance in the second negative electrode active material, as long as the purpose of this application can be achieved. For example, the mass percentage of the silicon-containing substance in the second negative electrode active material can be controlled by adjusting the mass percentage of the added silicon-containing substance.

In this application, the second negative electrode active material may further include a carbon material. Based on the mass of the second negative electrode active material, a mass percentage of the carbon material is C₂%, where 0≤C₂≤98. For example, the value of C₂ may be 0, 10, 20, 30, 40, 50, 60, 70, 80, 90, 98, or in a range defined by any two of the above values.

In one embodiment of this application, based on the mass of the third negative electrode material layer, a mass percentage of the first negative electrode active material is H₁%, and based on the mass of the fourth negative electrode material layer, a mass percentage of the second negative electrode active material is H₂%, where 0.1≤H₂−H₁≤10, preferably 1≤H₂−H₁≤5. For example, the value of H₂−H₁ may be 0.1, 0.2, 0.5, 1, 1.5, 2, 2.5, 3, 3.5, 4, 4.5, 5, 5.5, 6, 6.5, 7, 7.5, 8, 8.5, 9, 9.5, 10, or in a range defined by any two of the above values. When the difference between the mass percentage of the second negative electrode active material and the mass percentage of the first negative electrode active material is within the range of this application, the mass percentage of the second negative electrode active material matches the mass percentage of the first negative electrode active material, allowing for regulation of the mass percentages of silicon element and lithium element in different negative electrode material layers, so that both the second negative electrode active material and the first negative electrode active material have a relatively high lithium supplementation amount. This can further improve the initial Coulombic efficiency of the secondary battery, further reduce cycling capacity degradation, and further enhance the energy density of the secondary battery. In this application, 65≤H₁≤98.9, and 75≤H₂≤99.

This application does not specifically limit the method for controlling the mass percentage of the first negative electrode active material and the mass percentage of the second negative electrode active material, as long as the purpose of this application can be achieved. For example, the mass percentage of the first negative electrode active material can be controlled by adjusting the mass percentage of the added first negative electrode active material; and the mass percentage of the second negative electrode active material can be controlled by adjusting the mass percentage of the added second negative electrode active material. This application does not specifically limit the method for controlling H₂−H₁, as long as the purpose of this application can be achieved. For example, the value of H₂−H₁ can be controlled by adjusting the respective values of H₂ and H₁, with the adjustment methods as described above.

In one embodiment of this application, an areal density of the third negative electrode material layer is CW₃ mg/cm², and an areal density of the fourth negative electrode material layer is CW₄ mg/cm², where 0.8≤CW₃≤50, preferably 1.0≤CW₃≤13.0. For example, the value of CW₃ may be 0.8, 1, 3, 5, 7, 10, 13, 15, 17, 20, 23, 25, 27, 30, 33, 35, 37, 40, 43, 45, 47, 50, or in a range defined by any two of the above values; and 0.25≤CW₄/CW₃≤1. For example, the value of CW₄/CW₃ may be 0.25, 0.3, 0.4, 0.5, 0.6, 0.7, 0.8, 0.9, 1, or in a range defined by any two of the above values. When the areal density of the third negative electrode material layer and the ratio of the areal density of the fourth negative electrode material layer to the areal density of the third negative electrode material layer are within the ranges of this application, the areal density of the third negative electrode material layer matches the areal density of the fourth negative electrode material layer, allowing both the second negative electrode active material and the first negative electrode active material to have a relatively high lithium supplementation amount. This can further improve the initial Coulombic efficiency of the secondary battery, further reduce cycling capacity degradation, and further enhance the energy density of the secondary battery. In this application, 0.2≤CW₄≤50.

This application does not specifically limit the method for controlling the areal densities of the third negative electrode material layer and the fourth negative electrode material layer, as long as the purpose of this application can be achieved. It can be understood that the areal density of the third negative electrode material layer is related to the areal density of the first negative electrode material layer, with the areal density of the third negative electrode material layer being the sum of the areal density of the first negative electrode material layer and the lithium supplementation areal density; and the areal density of the fourth negative electrode material layer is related to the areal density of the second negative electrode material layer, with the areal density of the fourth negative electrode material layer being the sum of the areal density of the second negative electrode material layer and the lithium supplementation areal density. The areal density of the third negative electrode material layer can be controlled by adjusting the areal density of the first negative electrode material layer and/or the lithium supplementation areal density, and the areal density of the fourth negative electrode material layer can be controlled by adjusting the areal density of the second negative electrode material layer and/or the lithium supplementation areal density. For example, during application of the first negative electrode slurry on the surface of the negative electrode current collector, on the basis of a fixed solid content of the first negative electrode slurry, increasing the coating amount of the first negative electrode slurry can increase the areal density of the first negative electrode material layer. During application of the second negative electrode slurry on the surface of the first negative electrode material layer, on the basis of a fixed solid content of the second negative electrode slurry, increasing the coating amount of the second negative electrode slurry can increase the areal density of the second negative electrode material layer. For example, the lithium supplementation areal density can be controlled by adjusting the interface pressure, lamination time, and lamination temperature during the prelithiation treatment. This application does not specifically limit the method for controlling CW₄/CW₃, as long as the purpose of this application can be achieved. For example, the value of CW₄/CW₃ can be controlled by adjusting the respective values of CW₄ and CW₃, with the adjustment methods as described above.

In one embodiment of this application, the silicon-containing substance includes at least one of a silicon-carbon material or a silicon-oxygen material. In this application, the silicon-carbon material is a silicon-carbon composite material, and based on a mass of the silicon-carbon composite material, a mass percentage of silicon element is 30% to 70%, and a mass percentage of carbon element is 30% to 70%. This application does not specifically limit the silicon-carbon composite material, as long as the purpose of this application can be achieved. For example, the silicon-carbon composite material may be a composite material obtained by deposition. For example, the silicon-carbon composite material may be a silicon material deposited on a carbon framework, or a carbon material deposited on a silicon framework. The silicon-oxygen material includes SiOₓ, where 0<x<2. For example, the silicon-oxygen material may include silicon monoxide (SiO, with a molar ratio of silicon to oxygen of 1:1). When the negative electrode plate satisfies the above structure, the use of the foregoing silicon-containing substance allows the second negative electrode active material to have a relatively high lithium supplementation amount. This can further improve the initial Coulombic efficiency of the secondary battery, further reduce cycling capacity degradation, and further enhance the energy density of the secondary battery.

In this application, the first negative electrode material layer further includes a negative electrode binder and a negative electrode conductive agent, and the second negative electrode material layer further includes a negative electrode binder and a negative electrode conductive agent. This application does not specifically limit the type of the negative electrode binder, as long as the purpose of this application can be achieved. For example, the negative electrode binder may include at least one of polyacrylate, polyimide, polyamide, polyamideimide, polyvinylidene fluoride, polystyrene-butadiene copolymer (styrene-butadiene rubber, SBR), sodium alginate, polyvinyl alcohol, polytetrafluoroethylene, polyacrylonitrile, sodium carboxymethyl cellulose, potassium carboxymethyl cellulose, lithium carboxymethyl cellulose, lithium polyacrylate, sodium hydroxymethyl cellulose, or potassium hydroxymethyl cellulose. This application does not specifically limit the type of the negative electrode conductive agent, as long as the purpose of this application can be achieved. For example, the negative electrode conductive agent may include, but is not limited to, at least one of conductive carbon black, carbon nanotubes (CNTs), carbon fiber, flake graphite, graphene, metal material, or conductive polymer. The above metal material may include, but is not limited to, metal powder and/or metal fiber. Specifically, the metal may include, but is not limited to, at least one of copper, nickel, aluminum, or silver. The conductive polymer may include, but is not limited to, at least one of polyphenylene derivative, polyaniline, polythiophene, polyacetylene, or polypyrrole. This application does not specifically limit the mass percentages of the negative electrode binder and the negative electrode conductive agent in the first negative electrode material layer, which can be selected by those skilled in the art according to actual needs, as long as the purpose of this application can be achieved. This application does not specifically limit the mass percentages of the negative electrode binder and the negative electrode conductive agent in the second negative electrode material layer, which can be selected by those skilled in the art according to actual needs, as long as the purpose of this application can be achieved.

This application does not specifically limit the negative electrode current collector, as long as the purpose of this application can be achieved. For example, it may be copper foil, copper alloy foil, nickel foil, stainless steel foil, titanium foil, nickel foam, copper foam, or a composite current collector (for example, a lithium-copper composite current collector, a carbon-copper composite current collector, a nickel-copper composite current collector, or a titanium-copper composite current collector).

This application does not specifically limit the thickness of the negative electrode current collector, as long as the purpose of this application can be achieved. For example, the thickness of the negative electrode current collector is 4 μm to 20 μm. This application does not specifically limit the thicknesses of the first negative electrode material layer and the second negative electrode material layer, as long as the purpose of this application can be achieved. For example, a single-sided thickness of the first negative electrode material layer is 8 μm to 265 m; and a single-sided thickness of the second negative electrode material layer is 2 μm to 265 μm.

A fourth aspect of this application provides a secondary battery including the prelithiated negative electrode plate according to any one of the foregoing embodiments. Therefore, the secondary battery provided in this application has a high initial Coulombic efficiency, low cycling capacity degradation, and high energy density.

In this application, the secondary battery further includes a positive electrode plate. The positive electrode plate includes a positive electrode current collector and a positive electrode material layer disposed on at least one surface of the positive electrode current collector. The “positive electrode material layer disposed on at least one surface of the positive electrode current collector” means that the positive electrode material layer may be disposed on one surface of the positive electrode current collector along its thickness direction, or may be disposed on two surfaces of the positive electrode current collector along its thickness direction. It should be noted that the “surface” herein may be the entire region of the positive electrode current collector or a partial region of the positive electrode current collector, which is not specifically limited in this application, as long as the purpose of this application can be achieved.

This application does not specifically limit the positive electrode current collector, as long as the purpose of this application can be achieved. For example, it may be aluminum foil, aluminum alloy foil, or a composite current collector (for example, an aluminum-carbon composite current collector).

The positive electrode material layer of this application includes a positive electrode active material, where the positive electrode active material includes a substance capable of reversibly intercalating and deintercalating active ions such as lithium ions. The positive electrode material layer may be one layer or multiple layers, and each layer in a multi-layer positive electrode material layer may include the same or different positive electrode active materials. This application does not specifically limit the positive electrode active material, as long as the purpose of this application can be achieved. For example, the positive electrode active material may include, but is not limited to, at least one of lithium nickel cobalt manganese oxide, lithium nickel cobalt aluminum oxide, lithium iron phosphate, lithium-rich manganese-based material, lithium cobalt oxide (LiCoO₂), lithium manganese oxide, lithium manganese iron phosphate, or lithium titanate. The lithium nickel cobalt manganese oxide may include at least one of LiNi_{0.95}Co_{0.03}Mn_{0.02}O₂(Ni95), LiNi_{0.91}Co_{0.03}Mn_{0.06}O₂(Ni91), LiNi_{0.8}Co_{0.1}Mn_{0.1}O₂ (NCM811), LiNi_{0.6}Co_{0.2}Mn_{0.2}O₂ (NCM622), LiNi_{0.5}Co_{0.2}Mn_{0.3}O₂ (NCM523), or LiNi_{1/3}Co_{1/3}Mn_{1/3}O₂ (NCM111). The positive electrode material layer of this application further includes a positive electrode conductive agent and a positive electrode binder. This application does not specifically limit the positive electrode conductive agent and the positive electrode binder, as long as the purpose of this application can be achieved. For example, the positive electrode conductive agent may include at least one of the foregoing negative electrode conductive agents; and the positive electrode binder may include at least one of the foregoing negative electrode binders. This application does not specifically limit the mass ratio of the positive electrode active material, positive electrode conductive agent, and positive electrode binder in the positive electrode material layer, which can be selected by those skilled in the art according to actual needs, as long as the purpose of this application can be achieved.

This application does not specifically limit the thickness of the positive electrode current collector, as long as the purpose of this application can be achieved. For example, the thickness of the positive electrode current collector is 6 μm to 25 μm. This application does not specifically limit the thickness of the positive electrode material layer, as long as the purpose of this application can be achieved. For example, the thickness of a single-sided positive electrode material layer is 25 μm to 250 μm.

In this application, the secondary battery further includes an electrolyte. The electrolyte includes a lithium salt. This application does not specifically limit the type of the lithium salt, and any lithium salts known in the art can be used. For example, the lithium salt may include, but is not limited to, at least one of lithium hexafluorophosphate (LiPF₆), lithium bis(trifluoromethanesulfonyl)imide (LiN(CF₃SO₂)₂, LiTFSI), lithium bis(fluorosulfonyl)imide (Li(N(SO₂F)₂), LiFSI), lithium difluorophosphate (LiPO₂F₂), lithium bis(oxalate)borate (LiB(C₂O₄)₂, LiBOB), or lithium difluoro(oxalate)borate (LiBF₂(C₂O₄), LiDFOB). This application does not specifically limit the mass percentage of the lithium salt in the electrolyte, as long as the purpose of this application can be achieved. The electrolyte further includes a non-aqueous organic solvent. This application does not specifically limit the non-aqueous organic solvent, as long as the purpose of this application can be achieved. For example, the non-aqueous organic solvent may include at least one of carbonate compound, carboxylate compound, ether compound, or another organic solvent. The carbonate compound may include, but is not limited to, at least one of linear carbonate compound, cyclic carbonate compound, or fluorinated carbonate compound. The linear carbonate compound may include, but is not limited to, at least one of dimethyl carbonate (DMC), diethyl carbonate (DEC), dipropyl carbonate (DPC), methyl propyl carbonate (MPC), ethyl propyl carbonate (EPC), or methyl ethyl carbonate (EMC). The cyclic carbonate compound may include, but is not limited to, at least one of ethylene carbonate (EC), vinylene carbonate, propylene carbonate (PC), butylene carbonate (BC), or vinyl ethylene carbonate (VEC). The fluorinated carbonate compound may include, but is not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, or propyl propionate. The ether compound may include, but is not limited to, at least one of dibutyl ether, tetraglyme, diglyme, 1,2-dimethoxyethane, 1,2-diethoxyethane, ethoxymethoxyethane, 2-methyltetrahydrofuran, or tetrahydrofuran. The another organic solvent may include, but is not limited to, at least one of 1,3-propane sultone, dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, or phosphate ester. This application does not specifically limit the mass percentage of the non-aqueous organic solvent in the electrolyte, as long as the purpose of this application can be achieved.

In this application, the secondary battery further includes a separator. The separator is configured to separate the positive electrode plate and the negative electrode plate, preventing internal short circuits in the secondary battery, and allowing electrolyte ions to pass freely without affecting the electrochemical charge-discharge process. This application does not specifically limit the separator, as long as the purpose of this application can be achieved. For example, the material of the separator may include, but is not limited to, at least one of polyolefin (PO) mainly including polyethylene (PE) or polypropylene (PP), polyester (for example, a polyethylene terephthalate (PET) film), cellulose, polyimide (PI), polyamide (PA), spandex, or aramid; and the type of separator may include at least one of woven film, non-woven film, microporous film, composite film, calendered film, or spun film.

In this application, the separator may include a substrate and a surface treatment layer. The substrate may be a non-woven fabric or composite film with a porous structure, and the material of the substrate may include at least one of polyethylene, polypropylene, polyethylene terephthalate, or polyimide. Optionally, a polypropylene porous film, a polyethylene porous film, a polypropylene non-woven fabric, polyethylene non-woven fabric, or a polypropylene-polyethylene-polypropylene porous composite film may be used. Optionally, the surface treatment layer is disposed on at least one surface of the substrate, and the surface treatment layer may be a polymer layer or an inorganic layer, or a layer formed by mixing a polymer and an inorganic substance. For example, the inorganic layer includes inorganic particles and a separator binder. This application does not specifically limit the inorganic particles. For example, the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. This application does not specifically limit the separator binder. For example, the separator binder may be at least one of the foregoing negative electrode binders. The polymer layer includes a polymer, and the material of the polymer includes at least one of polyamide, polyacrylonitrile, acrylate polymer, polyacrylic acid, polyvinylpyrrolidone, polyvinyl ether, polyvinylidene fluoride, or vinylidene fluoride-hexafluoropropylene copolymer.

The secondary battery of this application further includes a packaging bag for accommodating the positive electrode plate, separator, prelithiated negative electrode plate, and electrolyte, as well as other components known in the art in the secondary battery. This application does not limit the other components. This application does not specifically limit the packaging bag, and it may be a packaging bag known in the art, as long as the purpose of this application can be achieved.

This application does not specifically limit the type of secondary battery, and it may include any apparatus in which an electrochemical reaction takes place. In this application, the secondary battery may include, but is not limited to, a lithium metal secondary battery, a lithium-ion secondary battery (a lithium-ion battery), a lithium polymer secondary battery, a lithium-ion polymer secondary battery (a lithium-ion polymer battery), or the like.

The preparation process of the secondary battery of this application is well known to those skilled in the art, and is not specifically limited in this application. For example, the preparation process may include, but is not limited to, the following steps: stacking the positive electrode plate, separator, and prelithiated negative electrode plate in order, and performing operations such as winding or folding as needed to obtain an electrode assembly with a wound structure, placing the electrode assembly in a packaging bag, injecting the electrolyte into the packaging bag, and sealing it to obtain a secondary battery; or stacking the positive electrode plate, separator, and prelithiated negative electrode plate in order, and fixing the four corners of the entire resulting stacked structure with tape to obtain an electrode assembly with a stacked structure, placing the electrode assembly in a packaging bag, injecting the electrolyte into the packaging bag, and sealing it to obtain a secondary battery. In addition, components such as overcurrent protection elements and guide plates can be placed in the packaging bag as needed to prevent pressure rise, overcharge, and overdischarge inside the secondary battery.

A fifth aspect of this application provides an electronic apparatus including the secondary battery according to any one of the foregoing embodiments. Therefore, the electronic apparatus provided in this application has a high initial Coulombic efficiency, low cycling capacity degradation, and high energy density.

This application does not specifically limit the type of electronic apparatus, and it may be any electronic apparatus known in the prior art. In some embodiments, the electronic apparatus may include, but is not limited to, a notebook computer, a pen-input computer, a mobile computer, an e-book player, a portable phone, a portable fax machine, a portable copier, a portable printer, a head-mounted stereo earphone, a video recorder, an LCD TV, a portable cleaner, a portable CD player, a mini disc, a transceiver, an electronic notebook, a calculator, a memory card, a portable recorder, a radio, a backup power supply, a motor, an automobile, a motorcycle, a power-assisted bicycle, a bicycle, a lighting fixture, a toy, a gaming console, a clock, an electric tool, a flashlight, a camera, a large household battery, a lithium-ion capacitor, and the like.

### EXAMPLES

The following describes the embodiments of this application more specifically by using examples and comparative examples. Various tests and evaluations are conducted according to the methods described below. Unless otherwise specified, “part” and “%” are based on mass.

### Test Methods and Equipment:

### Mass Percentage Tests for Elements in Negative Electrode Material Layer:

A prelithiated negative electrode plate was taken, and the prelithiated negative electrode plate was cut into a 6 mm×6 mm sample and attached to a sample stage using conductive adhesive. Subsequently, the cross-section of the sample was polished using a cross-section polisher (cross section polisher, model: IB-19520CCP) with the following polishing conditions: vacuum degree at 10⁻³ Pa, acceleration voltage at 6 kV, and polishing speed at 500 microns/hour. The polished sample was placed on the sample stage of a scanning electron microscope, and its cross-section was tested using the scanning electron microscope (SEM, Scanning electron microscope, model: Thermo Fisher FEI-Apreo S) with the following testing conditions: acceleration voltage at 10 kV, raster at 10 spots, working distance WD at 10 mm, and magnification at 2000×. The layer containing irregular silicon particles was the fourth negative electrode material layer, while the layer without irregular silicon particles was the third negative electrode material layer. The thickness of the fourth negative electrode material layer was measured at 10 positions, and the average value, Thk₄, was calculated. The thickness of the third negative electrode material layer was measured at 10 positions, and the average value, Thk₃, was calculated.

A region of the prelithiated negative electrode plate containing double-sided negative electrode material layers was selected, from which 10 small discs with an area of 1540.25 mm² were cut using a cutting machine. A thickness of Thk₄ was wiped off from the surface of the negative electrode material layer on these 10 small discs, and the wiped-off powder was collected as the fourth negative electrode material layer powder. The mass percentage of silicon element and the mass percentage of lithium element in the fourth negative electrode material layer powder was analyzed using an inductively coupled plasma-optical emission spectrometer (ICP-OES). Subsequently, the remaining negative electrode material layer with a thickness of Thk₃ on the 10 small discs was wiped off, and the wiped-off powder was collected as the third negative electrode material layer powder. The mass percentage of silicon element and the mass percentage of lithium element in the third negative electrode material layer powder were analyzed using the ICP-OES. The ICP-OES used was a PE7000DV spectrometer manufactured by PerkinElmer, USA. The test conditions of the ICP-OES were set as follows: radio frequency (RF) at 40.68 MHz, RF power at 1300 W, argon secondary pressure at 0.6 MPa, auxiliary gas flow rate at 0.2 L/min, cooling gas flow rate at 15 L/min, and pump speed at 1.5 mL/min.

### Areal Density Test:

A region of the prelithiated negative electrode plate containing double-sided negative electrode material layers was selected, from which 10 small discs with an area of 1540.25 mm² were cut using a cutting machine. A thickness of Thk₄ was wiped off from the surface of the negative electrode material layer on these 10 small discs, and the wiped-off powder was collected as the fourth negative electrode material layer powder. This powder was weighed three times, and the average value, M4, was calculated. Subsequently, the remaining negative electrode material layer with a thickness of Thk₃ on the 10 small discs was wiped off, and the wiped-off powder was collected as the third negative electrode material layer powder. This powder was weighed three times, and the average value, M3, was calculated. The areal density of the fourth negative electrode material layer, CW₄ (mg/cm²), was calculated as (M4×100000)/(2×1540.25), and the areal density of the third negative electrode material layer, CW₃ (mg/cm²), was calculated as (M3×100000)/(2×1540.25), where the unit of M4 is g, and the unit of M3 is g.

### Initial Coulombic Efficiency Test:

The voltage range was subject to that marked on the outer packaging of the factory-delivered battery. For example, when the factory-delivered battery was marked with a voltage range of 3.0 V to 4.45 V, the charging cutoff voltage was 4.45 V, and the discharging cutoff voltage was 3.0 V. The specific test steps were as follows: At 25° C., the lithium-ion battery of the examples or comparative examples was charged at a constant current of 0.2 C to the cutoff voltage of 4.45 V, then charged at a constant voltage of 4.45 V until the current was less than 0.05 C. After left standing for 5 minutes, the lithium-ion battery was discharged at a constant current of 0.2 C to the cutoff voltage of 3.0 V. The capacity in the charging process was recorded as C0, and the capacity in the discharging process was recorded as C1. The initial Coulombic efficiency was calculated using the following formula:

Initial Coulombic efficiency (%)=C1/C0×100%.

### Cycling Performance Test:

The voltage range was subject to that marked on the outer packaging of the factory-delivered battery. For example, when the factory-delivered battery was marked with a voltage range of 3.0 V to 4.45 V, the charging cutoff voltage was 4.45 V, and the discharging cutoff voltage was 3.0 V. The specific test steps were as follows: At 25° C., the lithium-ion battery of the examples or comparative examples was subjected to its first charge and discharge cycle. The lithium-ion battery was charged at a constant current of 0.2 C to the cutoff voltage of 4.45 V, then charged at a constant voltage of 4.45 V until the current was less than 0.05 C. After left standing for 5 minutes, the lithium-ion battery was discharged at a constant current of 0.2 C to the cutoff voltage of 3.0 V, and the discharge capacity of the lithium-ion battery was measured as A. Subsequently, in a 25° C. environment, 400 charge and discharge cycles were performed according to the above steps, and the discharge capacity of the lithium-ion battery at the 400th cycle was measured as B. The cycling capacity retention rate was calculated using the following formula:

Cycling capacity retention rate (%)=B/A×100%.

A larger value of the measured cycling capacity retention rate indicates a better cycling performance of the lithium-ion battery.

### Energy Density Test:

The voltage range was subject to that marked on the outer packaging of the factory-delivered battery. For example, when the factory-delivered battery was marked with a voltage range of 3.0 V to 4.45 V, the charging cutoff voltage was 4.45 V, and the discharging cutoff voltage was 3.0 V The specific test steps were as follows: At 25° C., the lithium-ion battery of the examples or comparative examples was charged at a constant current of 0.2 C to the cutoff voltage of 4.45 V, then charged at a constant voltage of 4.45 V until the current was less than 0.05 C. After left standing for 5 minutes, the lithium-ion battery was discharged at a constant current of 0.2 C to the cutoff voltage of 3.0 V, and then left standing for 5 minutes. The energy in the discharge process was recorded as the discharge energy E. The volume V (mm³) of the lithium-ion battery was calculated as length×width×height.

Energy density (Wh/L)=E/V×10⁶.

### Example 1-1

### <Preparation of Lithium Supplementation Composite Layer>

Under an ambient temperature of 25° C. and a humidity of 1.0%, the lithium foil was rolled onto a copper foil support layer with a thickness of 14 μm to form a lithium supplementation layer, subjected to a rolling pressure P12 of 1.5 T/10 mm, to obtain a lithium supplementation layer/support layer composite structure.

Under an ambient temperature of 25° C. and a humidity of 1.0%, interface particles of artificial graphite were applied onto the surface of the lithium supplementation layer by wiping to form an interface layer, followed by rolling with a rolling pressure P2 of 0.5 T/10 mm, a rolling temperature T1 of 90° C., and a rolling rest time t1 of 30 minutes, to form a lithium supplementation composite layer. The thickness of the interface layer in the lithium supplementation composite layer was 8 μm, the thickness of the lithium supplementation layer was 0.03 mm, and the tensile strength of the support layer along the tape-running direction of the lithium supplementation composite layer was 72 N/10 mm.

### <Preparation of Negative Electrode Plate>

The artificial graphite as the first negative electrode active material, acetylene black as the negative electrode conductive agent, styrene-butadiene rubber (SBR) as the negative electrode binder, and lithium carboxymethyl cellulose as the negative electrode binder were mixed at a weight ratio of 88:2:6:4, and deionized water was added as a solvent. The mixture was stirred to uniformity to obtain the first negative electrode slurry, where the solid content of the first negative electrode slurry was 28 wt %.

The second negative electrode active material, acetylene black as the negative electrode conductive agent, styrene-butadiene rubber (SBR) as the negative electrode binder, and lithium carboxymethyl cellulose as the negative electrode binder were mixed at a weight ratio of 98:0.5:1:0.5, and deionized water was added as a solvent. The mixture was stirred to uniformity to obtain the second negative electrode slurry, where the solid content of the second negative electrode slurry was 28 wt %. The second negative electrode active material included a silicon-carbon material and artificial graphite, with the silicon-carbon material being a silicon-carbon composite material. Based on the mass of the silicon-carbon composite material, the mass percentage of silicon element was 50%, and the mass percentage of carbon element was 50%. Based on the mass of the second negative electrode active material, the mass percentage of the silicon-containing substance was 30%, and the mass percentage of the carbon material was 70%.

The first negative electrode slurry was evenly applied onto one surface of a negative electrode current collector copper foil with a thickness of 12 μm, followed by drying at 90° C., to obtain a negative electrode plate coated with the first negative electrode material layer on one side. Subsequently, the second negative electrode slurry was evenly applied onto the surface of the first negative electrode material layer far from the negative electrode current collector copper foil, followed by drying at 90° C. to obtain a negative electrode plate sequentially coated with the first negative electrode material layer and the second negative electrode material layer on one side. The same steps were repeated on the other surface of the copper foil to obtain the negative electrode plate. The negative electrode plate was dried under vacuum at 90° C. for 1 hour, followed by cold pressing, cutting, and slitting, to obtain a negative electrode plate with specifications of 51 mm×44.2 mm. The areal density of the first negative electrode material layer was 5.94 mg/cm², the areal density of the second negative electrode material layer was 2.93 mg/cm², and the compaction density in the cold pressing process was 1.65 g/cm³. Based on the mass of the first negative electrode material layer, the mass percentage of silicon element in the first negative electrode material layer was WSi₁%, and based on the mass of the second negative electrode material layer, the mass percentage of silicon element in the second negative electrode material layer was WSi₂%, where WSi₁=0, WSi₂=14.7, and WSi₂>WSi₁.

### <Preparation of Prelithiated Negative Electrode Plate>

The prepared negative electrode plate was dried until the water content was less than or equal to 500 ppm. Under conditions of ambient temperature of 90° C. and humidity of 1.0%, the prepared lithium supplementation composite layer was laminated with the prepared negative electrode plate to bring the interface layer and the second negative electrode material layer into contact. Prelithiation treatment was performed with an interface pressure P3 of 0.6 MPa between the interface layer and the second negative electrode material layer, a lamination time t2 of 20 h between the interface layer and the second negative electrode material layer, and a lamination temperature T2 of 90° C. between the interface layer and the second negative electrode material layer. After the prelithiation treatment ended, the lithium supplementation composite layer was peeled off from the negative electrode plate, to form a prelithiated negative electrode plate.

### <Preparation of Positive Electrode Plate>

The lithium cobalt oxide (LiCoO₂) as the positive electrode active material, acetylene black as the positive electrode conductive agent, and polyvinylidene fluoride (PVDF) as the positive electrode binder were mixed at a weight ratio of 97:1.4:1.6, and N-methylpyrrolidone (NMP) was added as a solvent. The mixture was stirred to uniformity to obtain the positive electrode slurry, where the solid content of the positive electrode slurry was 75 wt %. The positive electrode slurry was evenly applied onto one surface of a positive electrode current collector aluminum foil with a thickness of 12 m, followed by drying at 110° C. to obtain a positive electrode plate coated with the positive electrode material layer on one side. The same steps were repeated on the other surface of the aluminum foil to obtain a positive electrode plate coated with the positive electrode material layers on two sides. The positive electrode plate was dried under vacuum at 110° C. for 1 hour, followed by cold pressing, cutting, and slitting, to obtain a positive electrode plate with specifications of 48 mm×41.2 mm. The areal density of the positive electrode material layer was 19.0 mg/cm², and the compaction density in the cold pressing process was 4.15 g/cm³.

### <Preparation of Electrolyte>

In an argon atmosphere glove box with a water content of less than 10 ppm, ethylene carbonate (EC), propylene carbonate (PC), diethyl carbonate (DEC), and ethyl propionate (EP) were mixed at a weight ratio of 3:1:3:3 to obtain a base solvent. The lithium salt lithium hexafluorophosphate (LiPF₆) was added and mixed to uniformity to obtain the electrolyte. Based on the mass of the electrolyte, the mass percentage of the lithium salt LiPF₆ was 12.5%, with the remainder being the base solvent.

### <Preparation of Separator>

A porous polypropylene film with a thickness of 5 μm (provided by Celgard) was used as the separator.

### <Preparation of Lithium-Ion Battery>

The prepared positive electrode plate, separator, prelithiated negative electrode plate, and separator were stacked in order, with the separator placed between the positive electrode plate and the prelithiated negative electrode plate to provide separation. The stack was wound to obtain an electrode assembly. After the tabs were welded, the electrode assembly was placed in an aluminum-plastic film packaging bag which was dried in a vacuum oven at 85° C. for 12 hours to remove moisture. The electrolyte was injected, and vacuum sealing, resting, formation (charged at a constant current of 0.02 C to 3.5 V, and then charged at a constant current of 0.1 C to 3.9 V), degassing, trimming, and capacity processing steps were performed to obtain a lithium-ion battery.

### Examples 1-2 to 1-9

The steps were the same as in Example 1-1, except that the relevant preparation parameters were adjusted according to Table 1.

### Examples 2-1 to 2-8

The steps were the same as in Example 1-3, except that the coating amount of the first negative electrode slurry and/or the coating amount of the second negative electrode slurry was adjusted to adjust the areal density of the first negative electrode material layer and/or the second negative electrode material layer such that the areal density of the third negative electrode material layer and/or the fourth negative electrode material layer was as shown in Table 2.

### Example 3-1

The steps are the same as in Example 1-3, except that the relevant preparation parameters were adjusted according to Table 3.

### Example 3-2

The steps are the as in Example 1-3, except that the lithium supplementation composite layer was prepared according to the following method.

### <Preparation of Lithium Supplementation Composite Layer>

Under an ambient temperature of 25° C. and a humidity of 1.0%, the lithium foil was rolled onto a copper foil support layer with a thickness of 14 μm to form a lithium supplementation layer, subjected to a rolling pressure P12 of 1.5 T/10 mm, to obtain a lithium supplementation layer/support layer composite structure.

Under an ambient temperature of 25° C. and a humidity of 1.0%, artificial graphite and acetylene black were first mixed to uniformity to obtain interface particles. These interface particles were then applied onto the surface of the lithium supplementation layer by wiping to form an interface layer. Rolling is performed with a rolling pressure P2 of 0.5 T/10 mm, a rolling temperature T1 of 90° C., and a rolling rest time t1 of 30 minutes, to form a lithium supplementation composite layer. Based on the mass of the interface particles, the mass percentage of the lithiation material was 80%, and the mass percentage of the conductive agent was 20%. The thickness of the interface layer in the lithium supplementation composite layer was 8 μm, the thickness of the lithium supplementation layer was 0.03 mm, and the tensile strength of the support layer along the tape-running direction of the lithium supplementation composite layer was 72 N/10 mm.

### Examples 3-3 to 3-5

The steps were the same as in Example 3-2, except that the relevant preparation parameters were adjusted according to Table 3.

### Comparative Example 1

The steps were the same as in Example 1-1, except that the negative electrode plate was prepared according to the following method.

### <Preparation of Negative Electrode Plate>

The negative electrode active material, acetylene black as the negative electrode conductive agent, styrene-butadiene rubber (SBR) as the negative electrode binder, and lithium carboxymethyl cellulose as the negative electrode binder were mixed at a weight ratio of 89:2:6:3. Deionized water was added as a solvent, and the mixture was stirred to uniformity to obtain the negative electrode slurry, where the solid content of the negative electrode slurry was 28 wt %. The negative electrode slurry was evenly applied onto one surface of a negative electrode current collector copper foil with a thickness of 12 μm, followed by drying at 90° C., to obtain a negative electrode plate coated with the negative electrode material layer on one side. The same steps were repeated on the other surface of the copper foil to obtain a negative electrode plate coated with the negative electrode material layers on two sides. The negative electrode plate was dried under vacuum at 90° C. for 1 hour, followed by cold pressing, cutting, and slitting, to obtain a negative electrode plate with specifications of 51 mm×44.2 mm. The negative electrode active material included a silicon-carbon material and artificial graphite, with the silicon-carbon material being a silicon-carbon composite material. Based on the mass of the silicon-carbon composite material, the mass percentage of silicon element was 50%, and the mass percentage of carbon element was 50%. Based on the mass of the negative electrode active material, the mass percentage of the silicon-containing substance was 10%, and the mass percentage of the carbon material was 90%. The areal density of the negative electrode material layer was 8.97 mg/cm², and the compaction density in the cold pressing process was 1.65 g/cm³.

### Comparative Example 2

The steps were the same as in Example 1-3, except that the negative electrode plate was prepared according to the following method.

### <Preparation of Negative Electrode Plate>

The first negative electrode active material, acetylene black as the negative electrode conductive agent, styrene-butadiene rubber (SBR) as the negative electrode binder, and lithium carboxymethyl cellulose as the negative electrode binder were mixed at a weight ratio of 88:2:6:4. Deionized water was added as a solvent, and the mixture was stirred to uniformity to obtain the first negative electrode slurry, where the solid content of the first negative electrode slurry was 28 wt %. The first negative electrode active material included a silicon-carbon material and artificial graphite, with the silicon-carbon material being a silicon-carbon composite material. Based on the mass of the silicon-carbon composite material, the mass percentage of silicon element was 50%, and the mass percentage of carbon element was 50%. Based on the mass of the first negative electrode active material, the mass percentage of the silicon-containing substance was 15%, and the mass percentage of the carbon material was 85%.

The artificial graphite as the second negative electrode active material, acetylene black as the negative electrode conductive agent, styrene-butadiene rubber (SBR) as the negative electrode binder, and lithium carboxymethyl cellulose as the negative electrode binder were mixed at a weight ratio of 91:2:4.5:2.5. Deionized water was added as a solvent, and the mixture was stirred to uniformity to obtain the second negative electrode slurry, where the solid content of the second negative electrode slurry was 28 wt %.

The first negative electrode slurry was evenly applied onto one surface of a negative electrode current collector copper foil with a thickness of 12 μm, followed by drying at 90° C., to obtain a negative electrode plate coated with the first negative electrode material layer on one side. Subsequently, the second negative electrode slurry was evenly applied onto the surface of the first negative electrode material layer far from the negative electrode current collector copper foil, followed by drying at 90° C. to obtain a negative electrode plate sequentially coated with the first negative electrode material layer and the second negative electrode material layer on one side. The same steps were repeated on the other surface of the copper foil to obtain the negative electrode plate. The negative electrode plate was dried under vacuum at 90° C. for 1 hour, followed by cold pressing, cutting, and slitting, to obtain a negative electrode plate with specifications of 51 mm×44.2 mm. The areal density of the first negative electrode material layer was 5.98 mg/cm², the areal density of the second negative electrode material layer was 2.99 mg/cm², and the compaction density in the cold pressing process was 1.65 g/cm³.

The preparation parameters, electrode plate performance parameters, and electrical performance parameters of each example and comparative example are shown in Tables 1 to 3.

TABLE 1

| | | | | Third negative electrode material layer | | | |
|---|---|---|---|---|---|---|---|
| | | | | | | Mass | Mass |
| | | | | | | percentage | percentage |
| | | | | | Mass | of negative | of negative |
| | | | | | percentage | electrode | electrode |
| | | | | | of negative | binder | binder |
| | | | | | electrode | styrene- | lithium |
| | | | | | conductive | butadiene | carboxymethyl |
| | CW₃ | CW₄ | | H₁ | agent | rubber | cellulose |
| | (mg/cm²) | (mg/cm²) | CW₄/CW₃ | (%) | (%) | (%) | (%) |
| Example 1-1 | 6 | 3 | 0.5 | 88 | 2 | 6 | 4 |
| Example 1-2 | 6 | 3 | 0.5 | 88 | 2 | 6 | 4 |
| Example 1-3 | 6 | 3 | 0.5 | 88 | 2 | 6 | 4 |
| Example 1-4 | 6 | 3 | 0.5 | 88 | 2 | 6 | 4 |
| Example 1-5 | 6 | 3 | 0.5 | 88 | 2 | 6 | 4 |
| Example 1-6 | 6 | 3 | 0.5 | 88 | 2 | 6 | 4 |
| Example 1-7 | 6 | 3 | 0.5 | 88 | 2 | 6 | 4 |
| Example 1-8 | 6 | 3 | 0.5 | 88 | 2 | 6 | 4 |
| Example 1-9 | 6 | 3 | 0.5 | 88 | 2 | 6 | 4 |
| Comparative | / | / | / | / | / | / | / |
| Example 1 | | | | | | | |
| Comparative | 6 | 3 | 0.5 | 88 | 2 | 6 | 4 |
| Example 2 | | | | | | | |

| | Fourth negative electrode material layer | | | | | | | | | |
|---|---|---|---|---|---|---|---|---|---|---|
| | | | | | Mass | Mass | | | | |
| | | | | | percentage | percentage | | | | |
| | | | | Mass | of negative | of negative | | | | |
| | | | | percentage | electrode | electrode | | | | |
| | | | | of negative | binder | binder | | | | |
| | | | | electrode | styrene- | lithium | | | | |
| | | | | conductive | butadiene | carboxymethyl | | | | |
| | H₂ | S₂ | C₂ | agent | rubber | cellulose | WSi₃ | WLi₃ | WSi₄ | WLi₄ |
| | (%) | (%) | (%) | (%) | (%) | (%) | (%) | (%) | (%) | (%) |
| Example 1-1 | 98 | 30 | 70 | 0.5 | 1 | 0.5 | 0 | 0.92 | 14.4 | 2.2 |
| Example 1-2 | 93 | 30 | 70 | 2 | 3.5 | 1.5 | 0 | 0.8 | 13.7 | 1.8 |
| Example 1-3 | 91 | 30 | 70 | 2 | 4.5 | 2.5 | 0 | 0.67 | 13.4 | 1.5 |
| Example 1-4 | 89 | 30 | 70 | 2 | 5 | 4 | 0 | 0.51 | 13.2 | 1.1 |
| Example 1-5 | 88.1 | 30 | 70 | 2 | 5.9 | 4 | 0 | 0.38 | 13.1 | 0.8 |
| Example 1-6 | 91 | 100 | 0 | 2 | 4.5 | 2.5 | 0 | 0.91 | 43.5 | 4.4 |
| Example 1-7 | 91 | 60 | 40 | 2 | 4.5 | 2.5 | 0 | 0.88 | 26.5 | 2.9 |
| Example 1-8 | 91 | 10 | 90 | 2 | 4.5 | 2.5 | 0 | 0.49 | 4.5 | 0.7 |
| Example 1-9 | 91 | 2 | 98 | 2 | 4.5 | 2.5 | 0 | 0.36 | 0.9 | 0.40 |
| Comparative | / | / | / | / | / | / | / | / | / | / |
| Example 1 | | | | | | | | | | |
| Comparative | 91 | 0 | 100 | 2 | 4.5 | 2.5 | 6.58 | 0.27 | 0 | 0.2 |
| Example 2 | | | | | | | | | | |

| | | | | | | Cycling | |
|---|---|---|---|---|---|---|---|
| | | | | | Initial | capacity | |
| | Relationship | | | | Coulombic | retention | Energy |
| | between WSi₄ | | | H₂ − | efficiency | rate | density |
| | and WSi₃ | WLi₄/WSi₄ | WLi₄/WLi₃ | H₁ | (%) | (%) | (Wh/L) |
| Example 1-1 | WSi₄ > WSi₃ | 15.3% | 2.4 | 10 | 95 | 80 | 865 |
| Example 1-2 | WSi₄ > WSi₃ | 13.1% | 2.3 | 5 | 93.5 | 83 | 860 |
| Example 1-3 | WSi₄ > WSi₃ | 11.2% | 2.2 | 3 | 92 | 90 | 850 |
| Example 1-4 | WSi₄ > WSi₃ | 8.3% | 2.2 | 1 | 90.5 | 86 | 820 |
| Example 1-5 | WSi₄ > WSi₃ | 6.1% | 2.1 | 0.1 | 89 | 82 | 795 |
| Example 1-6 | WSi₄ > WSi₃ | 10.1% | 4.8 | 3 | 89 | 78 | 870 |
| Example 1-7 | WSi₄ > WSi₃ | 10.9% | 3.3 | 3 | 91 | 83 | 860 |
| Example 1-8 | WSi₄ > WSi₃ | 15.6% | 1.4 | 3 | 91.5 | 85 | 840 |
| Example 1-9 | WSi₄ > WSi₃ | 44.4% | 1.1 | 3 | 91 | 82 | 830 |
| Comparative | / | / | / | / | 81 | 72 | 725 |
| Example 1 | | | | | | | |
| Comparative | WSi₄ < WSi₃ | / | 0.7 | 3 | 77 | 70 | 700 |
| Example 2 | | | | | | | |

Note:
In Table 1, “/” indicates no relevant preparation parameters.

From Examples 1-1 to 1-9 and Comparative Examples 1 to 2, it can be seen that using the prelithiated negative electrode plate of this application, with the structure of the prelithiated negative electrode plate within the range of this application, the mass percentage of silicon element in the fourth negative electrode material layer being greater than the mass percentage of silicon element in the third negative electrode material layer, and the ratio of the mass percentage of lithium element to the mass percentage of silicon element in the fourth negative electrode material layer being within the range of this application, the prepared lithium-ion battery has higher initial Coulombic efficiency, cycling capacity retention rate, and energy density, indicating that the solution in this application can improve the initial Coulombic efficiency of the lithium-ion battery, reduce cycling capacity degradation, and enhance the energy density of the lithium-ion battery. The structure of the prelithiated negative electrode plate in Comparative Example 1 is not within the range of this application, and the prepared lithium-ion battery has lower initial Coulombic efficiency, cycling capacity retention rate, and energy density. In Comparative Example 2, the mass percentage of silicon element in the third negative electrode material layer is greater than the mass percentage of silicon element in the fourth negative electrode material layer, and the prepared lithium-ion battery has lower initial Coulombic efficiency, cycling capacity retention rate, and energy density.

The mass percentage of lithium element in the fourth negative electrode material layer and its ratio to the mass percentage of lithium element in the third negative electrode material layer affect the initial Coulombic efficiency, cycling capacity retention rate, and energy density of the lithium-ion battery. From Examples 1-1 to 1-9, it can be seen that when the mass percentage of lithium element in the fourth negative electrode material layer and its ratio to the mass percentage of lithium element in the third negative electrode material layer are within the ranges of this application, the prepared lithium-ion battery has higher initial Coulombic efficiency, cycling capacity retention rate, and energy density, indicating that the solution in this application can improve the initial Coulombic efficiency of the lithium-ion battery, reduce cycling capacity degradation, and enhance the energy density of the lithium-ion battery.

The mass percentage of silicon element in the fourth negative electrode material layer affects the initial Coulombic efficiency, cycling capacity retention rate, and energy density of the lithium-ion battery. From Examples 1-1 to 1-9, it can be seen that when the mass percentage of silicon element in the fourth negative electrode material layer is within the range of this application, the prepared lithium-ion battery has higher initial Coulombic efficiency, cycling capacity retention rate, and energy density, indicating that the solution in this application can improve the initial Coulombic efficiency of the lithium-ion battery, reduce cycling capacity degradation, and enhance the energy density of the lithium-ion battery.

The mass percentage of the silicon-containing substance in the second negative electrode active material affects the initial Coulombic efficiency, cycling capacity retention rate, and energy density of the lithium-ion battery. From Examples 1-3 and 1-6 to 1-9, it can be seen that when the mass percentage of the silicon-containing substance in the second negative electrode active material is within the range of this application, the prepared lithium-ion battery has higher initial Coulombic efficiency, cycling capacity retention rate, and energy density, indicating that the solution in this application can improve the initial Coulombic efficiency of the lithium-ion battery, reduce cycling capacity degradation, and enhance the energy density of the lithium-ion battery. In Examples 1-3 and 1-6 to 1-9, with the mass percentage of the second negative electrode active material unchanged, as the mass percentage of the silicon-containing substance in the second negative electrode active material decreases, under the same lithium supplementation conditions, the lithium supplementation amount decreases, and the initial Coulombic efficiency of the lithium-ion battery is affected by both the mass percentage of the silicon-containing substance and the lithium supplementation amount, and the initial Coulombic efficiency of the lithium-ion battery first increases and then decreases.

The difference between the mass percentage of the second negative electrode active material and the mass percentage of the first negative electrode active material affects the initial Coulombic efficiency, cycling capacity retention rate, and energy density of the lithium-ion battery. From Examples 1-1 to 1-5, it can be seen that when the difference between the mass percentage of the second negative electrode active material and the mass percentage of the first negative electrode active material is within the range of this application, the prepared lithium-ion battery has higher initial Coulombic efficiency, cycling capacity retention rate, and energy density, indicating that the solution in this application can improve the initial Coulombic efficiency of the lithium-ion battery, reduce cycling capacity degradation, and enhance the energy density of the lithium-ion battery. In Examples 1-1 to 1-5, with the mass percentage of the silicon-containing substance in the second negative electrode active material unchanged, a decrease in the mass percentage of the second negative electrode active material affects the kinetic performance of the lithium-ion battery, and under the same lithium supplementation conditions, as the lithium supplementation amount decreases, the initial Coulombic efficiency of the lithium-ion battery decreases.

TABLE 2

| | | | | | | | | Relationship | | | Initial | Cycling | |
|---|---|---|---|---|---|---|---|---|---|---|---|---|---|
| | | | | | | | | between | | | Coulombic | capacity | Energy |
| | CW₃ | CW₄ | CW₄/ | WSi₃ | WLi₃ | WSi₄ | WLi₄ | WSi₄ and | WLi₄/ | WLi₄/ | efficiency | retention | density |
| | (mg/cm²) | (mg/cm²) | CW₃ | (%) | (%) | (%) | (%) | WSi₃ | WSi₄ | WLi₃ | (%) | rate (%) | (Wh/L) |
| Example | 6 | 3 | 0.5 | 0 | 0.67 | 13.4 | 1.5 | WSi₄ > | 11.2% | 2.2 | 92 | 90 | 850 |
| 1-3 | | | | | | | | WSi₃ | | | | | |
| Example | 0.8 | 0.4 | 0.5 | 0 | 0.92 | 13.4 | 2 | WSi₄ > | 14.9% | 2.2 | 95 | 88 | 830 |
| 2-1 | | | | | | | | WSi₃ | | | | | |
| Example | 1 | 0.5 | 0.5 | 0 | 0.84 | 13.4 | 1.8 | WSi₄ > | 13.4% | 2.1 | 93 | 89 | 840 |
| 2-2 | | | | | | | | WSi₃ | | | | | |
| Example | 13 | 6.5 | 0.5 | 0 | 0.34 | 13.5 | 0.7 | WSi₄ > | 5.2% | 2.1 | 90 | 85 | 875 |
| 2-3 | | | | | | | | WSi₃ | | | | | |
| Example | 30 | 15 | 0.5 | 0 | 0.17 | 13.6 | 0.4 | WSi₄ > | 2.9% | 2.4 | 81 | 75 | 890 |
| 2-4 | | | | | | | | WSi₃ | | | | | |
| Example | 50 | 25 | 0.5 | 0 | 0.08 | 13.6 | 0.2 | WSi₄ > | 1.5% | 2.5 | 78 | 73 | 900 |
| 2-5 | | | | | | | | WSi₃ | | | | | |
| Example | 6 | 1.5 | 0.25 | 0 | 0.9 | 13.4 | 2.1 | WSi₄ > | 15.7% | 2.3 | 92.5 | 90.2 | 845 |
| 2-6 | | | | | | | | WSi₃ | | | | | |
| Example | 6 | 4.5 | 0.75 | 0 | 0.51 | 13.5 | 1.1 | WSi₄ > | 8.1% | 2.2 | 91.2 | 86 | 852 |
| 2-7 | | | | | | | | WSi₃ | | | | | |
| Example | 6 | 6 | 1 | 0 | 0.42 | 13.5 | 0.9 | WSi₄ > | 6.7% | 2.1 | 90.8 | 83 | 855 |
| 2-8 | | | | | | | | WSi₃ | | | | | |

The areal density of the third negative electrode material layer and the ratio of the areal density of the fourth negative electrode material layer to the areal density of the third negative electrode material layer affect the initial Coulombic efficiency, cycling capacity retention rate, and energy density of the lithium-ion battery. From Examples 1-3 and 2-1 to 2-8, it can be seen that when the areal density of the third negative electrode material layer and the ratio of the areal density of the fourth negative electrode material layer to the areal density of the third negative electrode material layer are within the ranges of this application, the prepared lithium-ion battery has higher initial Coulombic efficiency, cycling capacity retention rate, and energy density, indicating that the solution in this application can improve the initial Coulombic efficiency of the lithium-ion battery, reduce cycling capacity degradation, and enhance the energy density of the lithium-ion battery.

In Examples 1-3, 2-2, and 2-1, under the same lithium supplementation conditions, as the areal densities of the third negative electrode material layer and the fourth negative electrode material layer gradually decrease, there is a possibility of excessive lithium supplementation, which affects the cycling performance of the lithium-ion battery, resulting in a gradual decrease in the cycling capacity retention rate of the lithium-ion battery. In Examples 1-3 and 2-3 to 2-5, as the areal densities of the third negative electrode material layer and the fourth negative electrode material layer gradually increase, the thicknesses of the third negative electrode material layer and the fourth negative electrode material layer gradually increase, which affects the kinetic performance of the lithium-ion battery, resulting in a gradual decrease in the cycling capacity retention rate of the lithium-ion battery. In Examples 1-3 and 2-6 to 2-8, as the areal density of the fourth negative electrode material layer increases, the thickness of the fourth negative electrode material layer increases, which affects the kinetic performance of the lithium-ion battery, resulting in a gradual decrease in the cycling capacity retention rate of the lithium-ion battery.

TABLE 3

| | Interface particles | | | | | | |
|---|---|---|---|---|---|---|---|
| | | Mass | | Mass | | | |
| | | percentage | | percentage | | | |
| | Lithiation | of lithiation | Conductive | of conductive | WSi₃ | WLi₃ | WSi₄ |
| | material | material (%) | agent | agent (%) | (%) | (%) | (%) |
| Example | Artificial | 100 | / | 0 | 0 | 0.67 | 13.4 |
| 1-3 | graphite | | | | | | |
| Example | SiO | 100 | / | 0 | 0 | 0.2 | 13.7 |
| 3-1 | | | | | | | |
| Example | Artificial | 80 | Acetylene | 20 | 0 | 0.4 | 13.6 |
| 3-2 | graphite | | black | | | | |
| Example | Artificial | 90 | Acetylene | 10 | 0 | 0.5 | 13.5 |
| 3-3 | graphite | | black | | | | |
| Example | Artificial | 99 | Acetylene | 1 | 0 | 0.55 | 13.5 |
| 3-4 | graphite | | black | | | | |
| Example | Artificial | 80 | Single- | 20 | 0 | 0.60 | 13.4 |
| 3-5 | graphite | | walled | | | | |
| | | | carbon | | | | |
| | | | nanotubes | | | | |

| | | | | | | Cycling | |
|---|---|---|---|---|---|---|---|
| | | Relationship | | | Initial | capacity | |
| | | between | | | Coulombic | retention | Energy |
| | WLi₄ | WSi₄ and | WLi₄/ | WLi₄/ | efficiency | rate | density |
| | (%) | WSi₃ | WSi₄ | WLi₃ | (%) | (%) | (Wh/L) |
| Example | 1.5 | WSi₄ > | 11.2% | 2.2 | 92 | 90 | 850 |
| 1-3 | | WSi₃ | | | | | |
| Example | 0.4 | WSi₄ > | 2.9% | 2.0 | 87 | 83 | 803 |
| 3-1 | | WSi₃ | | | | | |
| Example | 0.9 | WSi₄ > | 6.6% | 2.3 | 89.5 | 86.3 | 820 |
| 3-2 | | WSi₃ | | | | | |
| Example | 1.10 | WSi₄ > | 8.1% | 2.2 | 90 | 87 | 830 |
| 3-3 | | WSi₃ | | | | | |
| Example | 1.2 | WSi₄ > | 8.9% | 2.2 | 91 | 88.2 | 840 |
| 3-4 | | WSi₃ | | | | | |
| Example | 1.2 | WSi₄ > | 9.0% | 2.0 | 91.5 | 89 | 845 |
| 3-5 | | WSi₃ | | | | | |

The composition of the interface particles affects the lithium supplementation amount of the negative electrode active material in the prelithiated negative electrode plate, affecting the initial Coulombic efficiency, cycling capacity retention rate, and energy density of the lithium-ion battery. From Examples 1-3 and 3-1 to 3-5, it can be seen that when the interface particles include a lithiation material and a conductive agent, and the mass percentages of the lithiation material and the conductive agent are within the ranges of this application, the prepared lithium-ion battery has higher initial Coulombic efficiency, cycling capacity retention rate, and energy density, indicating that the solution in this application can improve the initial Coulombic efficiency of the lithium-ion battery, reduce cycling capacity degradation, and enhance the energy density of the lithium-ion battery.

It should be noted that in this specification, relational terms such as first and second are used solely to distinguish one entity or operation from another entity or operation, but do not necessarily require or imply any actual relationship or order between such entities or operations. Moreover, the terms “include,” “comprise,” or any other variants are intended to cover a non-exclusive inclusion, such that a process, method, or article that includes a list of elements not only includes those elements but also includes other elements that are not expressly listed, or further includes elements inherent to such process, method, or article.

The embodiments in this specification are described in an interrelated manner. For a part that is the same or similar between different embodiments, reference may be made between the embodiments. Each embodiment focuses on the differences from other embodiments.

The foregoing descriptions are merely preferred embodiments of this application, but are not intended to limit this application. Any modification, equivalent replacement, or improvement made without departing from the spirit and principle of this application shall fall within the protection scope of this application.

What is claimed is:

1. A preparation method of lithium supplementation composite layer, comprising the following steps:
(1) applying a lithium metal powder slurry onto a support layer, followed by drying and rolling, to form a lithium supplementation layer; or rolling lithium foil and/or lithium alloy foil onto a support layer to form a lithium supplementation layer; or applying a molten lithium or lithium alloy slurry onto a support layer, followed by cooling and rolling, to form a lithium supplementation layer; wherein a rolling pressure P1 is 0.2 T/10 mm to 1.8 T/10 mm; and
(2) applying interface particles onto a surface of the lithium supplementation layer to form an interface layer, followed by rolling, to form a lithium supplementation composite layer, wherein a rolling pressure P2 is 0.2 T/10 mm to 1.8 T/10 mm, a rolling temperature T1 is 20° C. to 180° C., and a rolling rest time t1 is 5 min to 60 min.

2. The preparation method according to claim 1, wherein the lithium supplementation composite layer comprises the support layer, the lithium supplementation layer, and the interface layer; wherein the lithium supplementation layer is disposed between the support layer and the interface layer;
the interface layer comprises the interface particles, wherein the interface particles comprise at least one of a conductive agent or a lithiation material; the conductive agent comprises at least one of conductive carbon black, carbon fiber, graphene, or carbon nanotubes; and the lithiation material comprises at least one of artificial graphite, natural graphite, hard carbon, silicon-carbon material, silicon-oxygen material, lithium titanate, tin, or tin-copper alloy; and
the lithium supplementation layer comprises at least one of lithium foil or lithium alloy foil.

3. The preparation method according to claim 2, wherein the interface particles comprise a lithiation material and a conductive agent; and based on a mass of the interface particles, a mass percentage of the lithiation material is 80% to 99%, and a mass percentage of the conductive agent is 1% to 20%.

4. A lithium supplementation method, comprising following steps:
drying a negative electrode plate; wherein the negative electrode plate comprises a negative electrode current collector, a first negative electrode material layer, and a second negative electrode material layer; wherein along a thickness direction of the negative electrode plate, the first negative electrode material layer is disposed between the negative electrode current collector and the second negative electrode material layer; and the second negative electrode material layer comprises a silicon-containing substance; and
based on a mass of the first negative electrode material layer, a mass percentage of silicon element in the first negative electrode material layer is WSi₁%, and based on a mass of the second negative electrode material layer, a mass percentage of silicon element in the second negative electrode material layer is WSi₂%, wherein WSi₂>WSi₁; and
laminating the lithium supplementation composite layer prepared using the preparation method according to claim 1 with the negative electrode plate to bring the interface layer and the second negative electrode material layer into contact, performing prelithiation treatment; and after the prelithiation treatment ends, peeling off the lithium supplementation composite layer from the negative electrode plate to form a prelithiated negative electrode plate.

5. The lithium supplementation method according to claim 4, wherein during the prelithiation treatment, an interface pressure P3 between the interface layer and the second negative electrode material layer is 0.1 MPa to 2 MPa, a lamination time t2 between the interface layer and the second negative electrode material layer is 0.5 h to 72 h, and a lamination temperature T2 between the interface layer and the second negative electrode material layer is 50° C. to 180° C.

6. A secondary battery, comprising the prelithiated negative electrode plate prepared using the lithium supplementation method according to claim 4, wherein the negative electrode plate comprises a negative electrode current collector, a third negative electrode material layer, and a fourth negative electrode material layer; wherein along a thickness direction of the negative electrode plate, the third negative electrode material layer is disposed between the negative electrode current collector and the fourth negative electrode material layer; the third negative electrode material layer comprises a first negative electrode active material, the fourth negative electrode material layer comprises a second negative electrode active material, and the second negative electrode active material comprises a silicon-containing substance; and
based on a mass of the third negative electrode material layer, a mass percentage of silicon element in the third negative electrode material layer is WSi₃%; and based on a mass of the fourth negative electrode material layer, a mass percentage of silicon element in the fourth negative electrode material layer is WSi₄%, and a mass percentage of lithium element in the fourth negative electrode material layer is WLi₄%; wherein WSi₄>WSi₃, and 1.5%≤WLi₄/WSi₄≤44.4%.

7. The secondary battery according to claim 6, wherein based on the mass of the third negative electrode material layer, a mass percentage of lithium element in the third negative electrode material layer is WLi₃%, wherein 1.1≤WLi₄/WLi₃≤4.8, and 0.2≤WLi₄≤4.4.

8. The secondary battery according to claim 6, wherein 0.9≤WSi₄≤43.5.

9. The secondary battery according to claim 6, wherein based on a mass of the second negative electrode active material, a mass percentage of the silicon-containing substance is S₂%, wherein 2≤S₂≤100.

10. The secondary battery according to claim 6, wherein based on the mass of the third negative electrode material layer, a mass percentage of the first negative electrode active material is H₁%; and based on the mass of the fourth negative electrode material layer, a mass percentage of the second negative electrode active material is H₂%; wherein 0.1≤H₂−H₁≤10.

11. The secondary battery according to claim 6, wherein an areal density of the third negative electrode material layer is CW₃ mg/cm², and an areal density of the fourth negative electrode material layer is CW₄ mg/cm², wherein 0.8≤CW₃≤50, and 0.25≤CW₄/CW₃≤1.

12. The secondary battery according to claim 6, wherein based on the mass of the third negative electrode material layer, a mass percentage of lithium element in the third negative electrode material layer is WLi₃%, wherein 1.4≤WLi₄/WLi₃≤3.3.

13. The secondary battery according to claim 6, wherein based on the mass of the third negative electrode material layer, a mass percentage of the first negative electrode active material is H₁%; and based on the mass of the fourth negative electrode material layer, a mass percentage of the second negative electrode active material is H₂%; wherein 1≤H₂−H₁≤5.

14. The secondary battery according to claim 6, wherein an areal density of the third negative electrode material layer is CW₃ mg/cm², wherein 1.0≤CW₃≤13.0.

15. The secondary battery according to claim 6, wherein the silicon-containing substance comprises at least one of a silicon-carbon material or a silicon-oxygen material.

16. The secondary battery according to claim 10, wherein an areal density of the third negative electrode material layer is CW₃ mg/cm², and an areal density of the fourth negative electrode material layer is CW₄ mg/cm², wherein 0.8≤CW₃≤50, and 0.25≤CW₄/CW₃≤1.

17. The secondary battery according to claim 16, wherein 1.0≤CW₃≤13.0.

18. The secondary battery according to claim 7, wherein an areal density of the third negative electrode material layer is CW₃ mg/cm², and an areal density of the fourth negative electrode material layer is CW₄ mg/cm², wherein 0.8≤CW₃≤50, and 0.25≤CW₄/CW₃≤1.

19. The secondary battery according to claim 16, wherein 1.0≤CW₃≤13.0.

20. The secondary battery according to claim 13, wherein an areal density of the third negative electrode material layer is CW₃ mg/cm², and an areal density of the fourth negative electrode material layer is CW₄ mg/cm², wherein 0.8≤CW₃≤50, and 0.25≤CW₄/CW₃≤1.
